(19) United States
(12) Patent Application Publication
(10) Pub. No.: US 2026/0127612 A1
(43) Pub. Date: May 7, 2026

(54) UNIFIED DIGITAL WALLET LINK ACCOUNT SYSTEMS AND METHODS

(71) Applicant: MASTERCARD INTERNATIONAL INCORPORATED, Purchase, NY (US)

(72) Inventors: Jaipal Singh Kumawat, Sikar (IN); Prasad Adam, Navi Mumbai (IN); Ved Pratap Singh Chauhan, Ghaziabad (IN)

(21) Appl. No.: 18/940,378

(22) Filed: Nov. 7, 2024

(51) Int. Cl. G06Q 20/40; G06Q 20/36; H04L 67/306

(52) U.S. Cl. CPC G06Q 20/4016; G06Q 20/363; G06Q 20/3672; H04L 67/306

(57) ABSTRACT

Systems and methods for providing a unified wallet link account (UWLA) computer system for generating a UWLA that is linked to funding accounts and external payment services. A unique identifier is generated and assigned to the UWLA and is used to link the UWLA to the external services. Transaction data of an account holder of the UWLA is processed by the UWLA to determine spending patterns of the account holder, and input parameters that are determined based on the spending patterns are used to electronically fund the UWLA.

### BACKGROUND OF THE DISCLOSURE

The field of the disclosure relates generally to improvements in managing unified payment transactions and digital wallets, and more specifically, to providing a centralized platform for users to seamlessly link multiple digital wallet applications, track transactions, and enhance security measures without compromising on convenience and user experience.

In today's digital banking landscape, users often face challenges in managing their financial transactions efficiently, especially when utilizing multiple digital wallet applications and other payment platforms and/or services including, but not limited to, payment services such as real-time payment (“RTP”) services. Such payment services including RTP services may be provided by third-party payment service platforms, services, and/or entities (referred to herein as an “RTP entity”), and may allow users to transfer money between bank accounts using their personal computing devices such as smartphones. For example, these payment services may enable transactions by linking multiple user financial accounts such as bank accounts to a single mobile application, and enabling peer-to-peer inter-bank transfers.

However, the lack of centralized control and visibility into these transactions can lead to confusion, security concerns, and inconvenience for users. Additionally, traditional banking accounts may not always offer seamless integration with popular digital wallet applications, requiring users to navigate multiple platforms to execute transactions.

Furthermore, the existing model of linking digital wallet applications directly to user's primary bank accounts poses security risks, as it exposes sensitive banking information to third-party applications. This lack of compartmentalization increases the vulnerability of user's financial assets to potential cyber threats and unauthorized access.

What is needed is a system and a method that addresses the shortcomings of existing financial management systems by (i) providing users with a dedicated account separate from their primary bank accounts, (ii) streamlining transaction management, (iii) improving security including improved fraud detection between different accounts, (iv) providing users with greater control over their financial activities, and (v) improving management of payment transactions and linked digital wallets, via a platform such as a centralized platform that allows users to seamlessly link multiple digital wallet applications, track transactions, and that offers enhance security measures, without compromising on convenience and user experience.

### BRIEF DESCRIPTION OF THE DISCLOSURE

In one embodiment, a computer system for a unified wallet link account (UWLA) computer system for providing a secure and intelligent unified wallet link account including at least one memory device for storing data and at least one processor in communication with the at least one memory device. The at least one processor programmed to: generate a unified wallet link account (UWLA) for a user based on user information, the user being an account holder of the UWLA; generate a unique identifier associated with the UWLA; electronically link the UWLA to (i) one or more funding accounts of the user, and (ii) one or more external payment services using the unique identifier; analyze, via one or more an artificial intelligence (AI) models associated with the UWLA, transaction data associated with the user and the one or more funding accounts; determine, based on an output of the one or more AI models, one or more spending patterns of the user from the analyzed transaction data; determine, based on the one or more spending patterns, input parameters for the UWLA; and electronically fund the UWLA based on the determined input parameters.

In another embodiment, a computer-implemented method for providing a unified wallet link account (UWLA) computer system for providing a secure and intelligent unified wallet link account using at least one processor in communication with at least one memory, the method including: generating a unified wallet link account (UWLA) for a user based on user information, the user being an account holder of the UWLA; generating a unique identifier associated with the UWLA; electronically linking the UWLA to (i) one or more funding accounts of the user, and (ii) one or more external payment services using the unique identifier; analyzing, via one or more an artificial intelligence (AI) models associated with the UWLA, transaction data associated with the user and the one or more funding accounts; determining, based on an output of the one or more AI models, one or more spending patterns of the user from the analyzed transaction data; determining, based on the one or more spending patterns, input parameters for the UWLA; and electronically funding the UWLA based on the determined input parameters.

In yet another embodiment, one or more non-transitory computer-readable storage media with instructions stored thereon that, in response to being executed, cause a unified wallet link account (UWLA) computer system for providing a secure and intelligent unified wallet link account to: generate a unified wallet link account (UWLA) for a user based on user information, the user being an account holder of the UWLA; generate a unique identifier associated with the UWLA; electronically link the UWLA to (i) one or more funding accounts of the user, and (ii) one or more external payment services using the unique identifier; analyze, via one or more an artificial intelligence (AI) models associated with the UWLA, transaction data associated with the user and the one or more funding accounts; determine, based on an output of the one or more AI models, one or more spending patterns of the user from the analyzed transaction data; determine, based on the one or more spending patterns, input parameters for the UWLA; and electronically fund the UWLA based on the determined input parameters.

### BRIEF DESCRIPTION OF THE DRAWINGS

FIGS. 1-10 illustrate exemplary embodiments of the systems and methods described herein.

FIG. 1 is a schematic diagram illustrating an example multi-party payment processing system for enabling payment transactions used in conjunction with a unified wallet link account (UWLA) computing system in accordance with one embodiment of the present disclosure.

FIG. 2 is a block diagram illustrating an example computer system representative of the UWLA computing system in the payment processing environment shown in FIG. 1.

FIG. 3A is a block diagram illustrating an example process flow diagram for the UWLA computing system according to one embodiment of the present disclosure.

FIG. 3B is a schematic diagram illustrating an example unique identifier issuance process for the UWLA computing system according to one embodiment of the present disclosure.

FIG. 4 is a block diagram illustrating an example embodiment of the UWLA computing system according to one embodiment of the present disclosure.

FIGS. 5A-5F are diagrams illustrating an example embodiment of a UWLA software application associated with the UWLA computing system according to one embodiment of the present disclosure.

FIG. 6A is a process flow diagram illustrating an artificial intelligence/machine learning module diagram associated with the UWLA computing system according to one embodiment of the present disclosure.

FIG. 6B is a process flow diagram illustrating the determination of various parameters used with the UWLA computing system according to one embodiment of the present disclosure.

FIG. 7 illustrates an example method for providing and implementing a UWLA according to one embodiment of the present disclosure.

FIG. 8 is a block diagram illustrating an example configuration of the UWLA computing system according to one embodiment of the present disclosure.

FIG. 9 is a block diagram illustrating an example configuration of a server and/or client computing device associated with the UWLA computing system according to one embodiment of the present disclosure.

FIG. 10 is a block diagram illustrating an example configuration of a user computing device associated with the UWLA computing system according to one embodiment of the present disclosure.

Like numbers in the Figures indicate the same or functionally similar components. Although specific features of various embodiments may be shown in some figures and not in others, this is for convenience only. Any feature of any figure may be referenced and/or claimed in combination with any feature of any other figure.

### DETAILED DESCRIPTION OF THE DISCLOSURE

The following detailed description illustrates embodiments of the present disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure. The disclosure is described as applied to an example embodiment, namely, methods and systems for providing a centralized platform for users to shield their primary bank accounts and seamlessly link multiple digital wallet applications, track transactions, and enhanced security measures without compromising on convenience and user experience.

The present disclosure provides a platform that addresses the challenges and shortcomings described herein of existing financial management systems, via an implementation of a unified wallet link account (UWLA) platform including a UWLA computing system. The UWLA platform, via the UWLA computing system, offers a dedicated banking account along with other technical aspects described herein that are specifically designed to facilitate seamless management of payments transactions such as real-time payment (RTP) transactions and linked digital wallets, providing users with enhanced security, control, and convenience.

In some embodiments, the UWLA platform includes a generation by the UWLA computing system of a specialized banking account. By offering users a dedicated account separate from their primary bank account(s), the UWLA streamlines transaction management, improves security, and provides users with greater control over their financial activities.

Through the implementation of the UWLA platform via the UWLA computing system, users benefit from a centralized platform for managing transactions such as real-time payment (RTP) transactions and linked digital wallets, enabling users to track their spending, enhancing security measures, and simplifying user's financial management processes. This solution not only addresses current pain points faced by users, but also aligns with the growing demand for innovative banking solutions that prioritize security, convenience, and user-centric design. For example, the UWLA systems and methods described herein include, but are not limited to, at least features 1 through 7 outlined below.
1. Dedicated Payment Account: The UWLA serves as a separate account within a banking system, distinct from a user's primary bank account(s). This compartmentalization ensures that the user's primary banking information remains secure and isolated while providing a dedicated platform for managing transactions such as real-time payment transactions (RTP) as well as linked digital wallets.
2. Unique Identifier Generation: Each UWLA is assigned a unique identifier such as a unique RTP identification (referred to herein as an “RTP ID”) that may be generated via the UWLA computing system that is used by an entity offering UWLAs to customers, such as a bank that offers UWLAs to their banking customers. Users can then link one or more UWLAs to their preferred digital wallet applications. The RTP ID is configured to function as a unique identifier and streamlines transaction initiation and eliminates the need for users to transfer funds to external digital wallet accounts before making payments.
3. Centralized Account Management: The UWLA provides users with a centralized platform for managing linked digital wallet applications and tracking transactions. Users can seamlessly link multiple digital wallet applications, view transaction history, and monitor their spending from a single interface within a platform such as their bank's digital banking platform.
4. Enhanced Security Measures: To bolster security, the UWLA implements robust authentication mechanisms and encryption protocols. Users may set up separate security credentials (e.g., PIN, password) specifically for accessing the UWLA, reducing the risk of unauthorized access and fraudulent activities. Additionally, the UWLA incorporates advanced fraud detection algorithms to identify and mitigate potential fraud and/or other security threats in real-time.
5. Streamlined Transaction Processing: Transactions initiated through linked digital wallet applications are seamlessly processed using the UWLA's unique RTP ID. Funds are electronically deducted directly from the UWLA, eliminating the need for manual fund transfers and streamlining the transaction process for users.
6. Comprehensive Transaction Tracking: All transactions conducted through linked digital wallet applications are recorded and tracked within the UWLA, providing users with a comprehensive centralized overview of their financial activities. Users can access transaction history, view detailed transaction records, and monitor their spending patterns in real-time.
7. User Support and Education: The UWLA provider, such as a bank, may provide comprehensive user support services to assist users with setting up and managing their UWLAs. Educational resources, tutorials, and FAQs may be made available to help users navigate the UWLA platform effectively and maximize its benefits.

Additional aspects of the UWLA systems and methods of the present disclosure, including information flow within the UWLA platform and other implementation steps within the UWLA platform include but are not limited to items (A) to (J) detailed below.
Item (A): An account creation process, including: (i) a user registration module configured to populate necessary data fields with personal information of a user (e.g., account holder); (ii) integration with various backend systems for user account creation and management; and (iii) implementation of validation (e.g., authorization) and verification (e.g., authentication) processes for user identification.
Item (B): Unique RTP ID generation, including: (i) utilization of an RTP ID generation algorithm; (ii) integration with a UWLA provider core system, such as a bank's core banking system, to assign and manage unique RTP IDs for each UWLA; and (iii) ensuring compliance with specifications and standards for RTP ID generation (which may include compliance with specifications and standards of payment services provided by an RTP entity such as Unified Payments Interface (UPI), Zelle, Venmo, and the like). An RTP ID can vary in format depending on the user's preferences and/or other factors such as requirements of the RTP entity, and may be in the format of an email address (e.g., all or part of the user's email address), all or part of the user's name (e.g., first name, initials, shortened name, etc.), a user's mobile phone number, a name of the user's bank, a string of characters and/or numbers, an alias, and the like.
Item (C): Linking digital wallet applications, including: (i) integration with various digital wallet application programming interfaces (APIs) for linking digital wallet applications to the UWLA; (ii) implementation of secure authorization mechanisms (e.g., using an authentication protocol, such as OAuth) for authorization and access control; and (iii) development of a user-friendly interface for users to initiate and manage the linking process.
Item (D): Transaction management, including: (i) integration with RTP entity infrastructure for processing RTP transactions; (ii) implementation of APIs for communication between the UWLA and bank accounts and/or linked wallet applications; and (iii) utilization of transaction processing logic to deduct funds from the UWLA for transactions such as digital wallet transactions.
Item (E): Transaction tracking, including: (i) a database configured for storing transaction data associated with each UWLA; (ii) implementation of logging and tracking mechanisms to record all transactions initiated through linked digital wallet applications; and (iii) utilization of reporting and/or querying functionalities for users to view their transaction history.
Item (F): Security measures, including: (i) implementation of strong encryption protocols to secure user data and transactions; (ii) integration with authentication systems for user access control (e.g., multi-factor authentication (“MFA”)); and (iii) implementation of fraud detection algorithms to identify and mitigate suspicious activities.
Item (G): Customer support and assistance, including: (i) integration with customer support tools (e.g., ticketing systems, live chat) for handling user inquiries and support requests; (ii) providing self-service options for users to troubleshoot common issues; and (iii) providing training for customer support staff to assist users with UWLA-related queries.
Item (H): Promotion and education, including: (i) preparation and distribution of marketing materials (e.g., brochures, videos) to promote the UWLA service; (ii) implementation of educational resources (e.g., FAQs, tutorials) within the UWLA provider's website and/or mobile application, such as a bank's website and/or mobile application; and (iii) promotional campaigns to increase awareness and adoption of UWLAs among users such as banking customers.
Item (I): Continuous improvement, including: (i) implementation of feedback mechanisms to gather user input and suggestions for improvements; (ii) agile development methodologies for iterative updates and enhancements to the UWLA system and services; (iii) monitoring of industry trends and technological advancements to incorporate new features and functionalities; and (iv) artificial intelligence (AI), including but not limited to machine learning to learn transaction patterns relating to spending and fraud, for example.
Item (J): Compliance and regulatory considerations, including (i) ensuring compliance with relevant banking regulations and RTP entity guidelines; (ii) conducting regular audits and assessments to maintain compliance with data security and privacy standards; and (iii) collaboration with regulatory bodies and industry associations to stay updated on regulatory changes affecting RTP services and/or digital wallet services.

Further regarding item (A) above, the account creation process may include but is not limited to: (1) data collection and verification; (2) account creation; (3) configuration and setup; and (4) notification and access.

In one embodiment, such as where a bank is the provider of the UWLA, data collection may include a user providing personal information such as their name, physical and email addresses, mobile phone number, and government identification and/or other identification documents. Verification may include, for example, the bank's system verifying the collected data using various databases (e.g., credit bureaus, government databases) to ensure the information is accurate and to comply applicable regulations such as with Know Your Customer (“KYC”) regulations. This may include performing a credit and/or fraud check to identify any potential red flags.

Once verified, account creation may proceed. Account creation may include user data being entered into a database of the bank's core banking system, creating a new account record, which may include generating an account number and/or one or more other account identifiers. For example, the bank's system may generate one or more unique account numbers and/or user aliases for the new account. This may involve the use of algorithms that ensure the numbers are unique and follow the bank's numbering conventions. For example, an account number may be an account number specific to the bank opening the account, whereas the account identifier may be the unique RTP ID linking the new bank account to the RTP entity service.

Once the data is entered and the account created, configuration and setup may proceed. Account configuration may include the system configuring the account with appropriate settings, such as funding levels and any linked services (e.g., digital wallets, RTP entity account, etc.). This may include security setup, such as multi-factor authentication and other security measures that are set up to protect the account.

Next, notification and access to the account may be provided. The user may receive confirmation of the new account, such as via email or text (e.g., SMS). The user may be asked to select banking credentials such as a user ID, password, and the like, for access provisioning purposes. The bank then reports the new account to relevant regulatory bodies to ensure compliance with financial regulations.

In some embodiments, the UWLA platform including the UWLA computing system includes business intelligence rules and/or machine learning models that help to manage the amount of money (also referred to herein as funds) maintained in an account (e.g., UWLA) within the UWLA platform. The UWLA platform may be linked to other bank accounts of the user, and these other bank accounts may be protected/insulated by automatically and electronically moving intelligently-determined funds from the user's bank accounts to the UWLA via AI/ML implementations. RTP IDs may be used as follows: the UWLA may be assigned its own RTP ID, and/or RTP IDs may be used to securely link to the primary accounts linked to the UWLA. For example, the UWLA may effectively stand in the place of a traditional bank account, serving as both a security buffer by shielding a user's primary bank accounts, while also serving as streamlined transaction platform capable of tracking spending in an advanced manner. The UWLA may log every transaction for use in spend analysis and/or fraud detection and to allow the user to monitor their spending across multiple accounts. The user's spending may be analyzed and utilized by the UWLA to learn about user spending habits, which may be used to keep the UWLA continuously funded with a certain amount of funds that the UWLA computing system has learned over time are sufficient to cover a user's typical spending needs, but with intelligence to keep only the amount typically needed by the user in the UWLA. This means that a UWLA may assist a user in keeping an optimized amount of money in their primary accounts to take benefit of accruing interest and/or other primary account incentives (e.g., reduced fees for storing a certain amount of money in the primary account), while still having sufficient funds in the UWLA for their purchasing needs. The UWLA is further specifically designed to facilitate seamless management of RTP entity transactions and linked digital wallets. A user may have a plurality of UWLAs. For example, one UWLA created within the UWLA platform may be linked to several digital wallets, or further compartmentalization may be utilized where individual UWLAs are linked to individual digital wallets, and each UWLA may have its own RTP ID.

Machine learning (ML) is a subset within the more general artificial intelligence (AI) field. AI/ML techniques and/or models may be used in conjunction with the UWLA system and methods described herein. ML involves the development and study of statistical algorithms that can be used to effectively perform tasks without explicit instructions on how to do it. For example, a machine learning model may be trained using historical data that enables the model to recognize patterns within the data and outputs resulting from those patterns. Thus, when the model is trained and applied to new data that is inputted into the model, the model is able to recognize those same patterns and predict an output based on the outputs from the historical data. Of course, in order to build and train the models that are subsequently used in the machine learning tools, it is beneficial to have quality data that is properly labeled and accurately represents the information that is desired to be learned about (although unlabeled data may also be used). The use of quality data having accurate labeling helps to ensure that the models that are trained and built will be able to accurately predict outcomes when applied to new data. ML has been applied and used in many areas and industry segments, including but not limited to large language models (LLMs), computer vision, speech recognition, email filtering, agriculture, medicine, insurance, and the financial or payment industry. In the payment industry, and as described herein, ML may be used in connection with determining patterns and/or gleaning other pertinent information relating to transactions, including the determining of spend and fraud patterns, etc.

In some embodiments, an overall process flow of establishing and implementing a UWLA platform includes the processes and/or other steps described below. The UWLA platform including the UWLA computing system may be configured as an overlay to a bank's core system. At the opening of a bank account such as a savings account at a bank, the customer may be provided the option to create a secure account (e.g., a UWLA) via the UWLA computing payment of the UWLA platform. If the customer agrees to open a UWLA, the UWLA platform is triggered to create a UWLA with a unique identifier (e.g., a unique RTP ID), which may be a secure, hashed-value token. In operation, the UWLA platform may include AI-based intelligence and/or other rules-based intelligence that determines, based on a user's normal spend, the amount of funds (e.g., how much money) needs to be periodically transferred (e.g., from the user's actual bank account(s)) and/or kept in the UWLA. This ensures (i) that there are always sufficient funds in the UWLA to cover the user's expenses, (ii) that the user does not have to repeatedly/constantly move funds into the UWLA, and (iii) that most funds are kept in the user's (e.g., primary) bank account, for example to maximize interest rate return. Relatedly, large sums of money may not be kept in the UWLA to protect that money from being exposed to hacks and/or other data breaches. The data analyzed by the model in connection with electronically funding the UWLA may be referred to herein as input parameters, and may include at least timing parameters and value parameters. In the example above, the timing parameter may represent a time period associated with the periodic transfers, and the value parameter may include an amount of funds that have been and/or need to transferred. These are just examples of the timing and value parameters and are not limiting.

Once the UWLA is created, the user can then link one or more other accounts (e.g., digital wallets including but not limited to Apple Pay, Google Pay, and the like, and/or other payments such as credit cards, other debit cards, and the like) to the RTP ID. The user can also link an alias to the RTP ID for easy retrieval of the RTP ID by the system. By performing such linking, the user creates an additional layer of security to the other actual accounts. When making a payment, the user may then use the RTP ID or alias (e.g., after securely accessing the UWLA with a user name and password and/or biometric) to make a payment. The system will provide the RTP ID (e.g., instead of a real primary account number (referred to herein as a “PAN”)) to the merchant, and the UWLA platform will determine the RTP ID is linked to one of the accounts within the UWLA for processing payment. This means that the actual PAN is not provided to a merchant or other payment recipient, but rather a tokenized RTP ID is provided and then linked up to the actual PAN on the backend. The linking by the UWLA platform between the RTP ID and the actual PAN can be done using other intelligence. For example, based on the particular merchant the user may be shopping with and/or other data, the UWLA platform may decide which actual payment account should be used and links that payment account to the RTP ID for that particular transaction, or the user may be prompted to asked which payment account they want to use for a particular purchase/transaction. The RTP ID is provided to the merchant (or the alias, such as an email address or phone number or the user) is used, and the RTP ID is retrieved and used to make the purchase. If for some reason there is a compromise with an actual payment account or the UWLA, the payment account(s) linked to the UWLA and/or the UWLA itself are able to be locked (for example at the UWLA level). A new RTP ID may then be generated and linked to those accounts, and new passwords can be set, so that purchasing ability can be restored with the new RTP ID. The prior RTP ID may be closed out and unable to be used.

Further regarding tokenization, authorization within the UWLA platform via the UWLA computing system may include, but is not limited, to tokenizing via an authorization protocol, as described herein. The authorization protocol is configured to allow the user to authorize one app or service to sign in to another without divulging certain information, such as private information including pin numbers, passwords, and the like. The authorization protocol grants permission to provide seamless connection with different apps and services without requiring the user to create a new account for each app/service. The authorization protocol balances convenience and security by being configured to provide simplicity of experience by providing the user the option to authorize one or more apps to share some of data of the user, without revealing the user's credentials.

The authorization protocol may be configured to work with Hypertext Transfer Protocol (HTTP). The authorization protocol may be configured to use access tokens to prove a user's identity and allow for interaction with another service on the user's behalf. In the event that such second service suffers a data breach, the user's credentials on the first service will remain safe. The authorization protocol may be further configured to not grant a third-party app or service unlimited access to user data. Rather, part of the protocol may include specifying which data the third party is allowed to access and what it can do with that data. Other limitations may also be implemented to further protect identities and other sensitive information.

For example, instead of a user sharing user credentials, the authorization protocol may be configured to send an authorization token (also referred to herein as an “access token” and/or a “key”) to another application to give a user access. In some embodiments, an access token is data that contains information about the user and the resource the token is intended for. A token may also include specific rules for data sharing. For example, a user may want to share certain information from one service to another, but only certain specific information. The token only authorizes access to the data approved by the user. There may also be rules governing when the application can use that token. For example, the token may be configured for a single use, recurring uses, and/or may have an expiration date. The authorization protocol may also be configured to delegate access, allowing third-party applications to access resources on behalf of the user, even when the user is not present. The authorization protocol may further be configured to revoke access, permitting the user to revoke the key at any time.

In the banking context, the authorization protocol may be configured to permit an app or service to access certain banking data of the user. The user may initiate a request to link their bank account with the app, authorizing only access to certain information such as their account balance, transactions, and the like. The app and the user's bank would use the authorization protocol to perform this exchange of information on behalf of the user without revealing the user's sign-in credentials to the app or other service.

The UWLA computing system of the UWLA platform may also use an authentication protocol for authentication functions (e.g., an authentication protocol such as Open ID Connect (OIDC)). Similar to the authorization protocol, the authentication protocol enables two or more unrelated apps/services to share certain information without compromising user data. The authentication protocol may be configured as an identity layer over top the authorization protocol.

In one embodiment, at the time of setup of a UWLA, the process may begin with an authorization request to set up a new RTP entity account associated with the UWLA. This request may be sent to the user, prompting the user to establish the conditions for recurring debits. As part of the authorization request, the user may receive a nominal deposit to one or more bank accounts associated with the setup process, which the user will need to confirm the amount of to authenticate the nominal deposit(s). This may be accomplished via multi-factor authentication (e.g., such as two-factor authentication (“2FA”)). For example, a user may be asked to enter a pin number and/or another ID, such as an ID associated with the RTP entity account or other account. This process functions to serve as a confirmation of the user's enrollment in the service. In some embodiments, this verification may be a one-time action, ensuring a secure setup. For example, a user may be asked to enter certain information, such as card number digits, expiry date, etc. from a debit card associated with one or more of the user's bank accounts. This may also include, for example, ATM pins used by the user at ATM's of the user's bank(s). In some embodiments, a one-time password (OTP) code may be sent to a user's mobile phone number, asking for entry of information such as an ATM pin. Once confirmed, the user may then be presented with the option to set a pin or other identifier for their RTP entity service account, such as an alias or the like.

The UWLA platform and/or UWLA may be accessible via a UWLA provider's website and/or mobile application (“app”). For example, for a pay request (e.g., to push funds), a user may log into the UWLA via the website or mobile app and chose to send funds/payment. The user may select the payee, which may include entering the payee's virtual ID (e.g., email address, mobile phone number, and the like), followed by the amount to be debited. The payer may then select the account that the funds will be drawn from. After reviewing a confirmation screen with payment details, the payer may enter their pin or other credentials to initiate the transaction. They will then receive either a success or failure message. A similar process exists for a collection request (e.g., to pull funds).

The UWLA platform mobile app may be configured to enable QR codes and the like, in addition to or alternative to pins and/or other credentials, to be used, and can be used for transactions spanning from merchant in-store sales to recurring bill pay for recurring services such as utilities (e.g., water, electricity, gas). The UWLA platform mobile app may also include banking-like features such as the ability to view account balances. For example, a QR code may be linked to the RTP ID and usable for providing payment in in-store transaction scenarios.

The participants in the UWLA platform described herein may include, but are not limited to, payer payment service provider (PSP), payee PSP, remitter bank, beneficiary bank, bank account holders and/or merchants (both online and/or in-store).

As described herein, digital banking users often face problems and other challenges in managing their financial transactions efficiently, due in part to the lack of centralized control and visibility into these transactions, which can lead to confusion, security concerns, and inconvenience for users. Additionally, traditional banking accounts may not always offer seamless integration with popular digital wallet applications, requiring users to navigate multiple platforms to execute transactions. The systems and methods of the present disclosure address these problems and challenges as described herein.

At least one technical effect of the systems and methods described herein is achieved by performing at least one of the following steps and/or causing at least one of the following results: (a) providing users with a dedicated account separate from their primary bank accounts; (b) streamlining transaction management, such as via a user-friendly user interface of a mobile application; (c) improving security via advanced security protocols, such as via implementing secure, hashed-value tokens representative of user accounts; (d) providing users with greater control over their financial activities, such as via a user-friendly user interface of a mobile application; (e) managing payment transactions and linked digital wallets, via a centralized platform that allows users to seamlessly link multiple digital wallet applications, track transactions, and that offers enhance security measures, without compromising on convenience and user experience; (g) implementing AI/ML and/or rules-based intelligence to determine financial patterns such as spend and/or fraud patterns; (h) intelligently managing account funds to ensure adherence to established user spend patterns and the presence of adequate funds, and avoid undesired and/or unnecessary amounts of funds in certain accounts; (i) reduced frequency of manually accessing user banking accounts via portals such as websites and/or mobile applications; (j) avoiding use of sensitive financial information such PANs; (k) creating additional layers of security and/or anonymity in digital banking; (l) presenting users with voluminous information and user controls within a limited graphical user interface display area such as a screen of a smartphone. More generally, a technical effect of the systems and methods described herein is improvements in banking and/or payment technology systems. The methods and systems described herein may be implemented using computer programming or engineering techniques including computer software, firmware, hardware or any combination or subset thereof.

By implementing the UWLA systems and methods in the present disclosure, UWLA providers such as banks can offer users a secure, user-friendly, and integrated platform for managing transactions such as real-time payment (RTP) transactions and linked digital wallets. The UWLA platform and each UWLA not only enhance security and convenience for users but also strengthen the bank's position in the competitive digital banking landscape by delivering innovative and value-added services to its customers.

Additional benefits of the UWLA systems and methods described herein include but are not limited to: (a) streamlined transaction management: users can manage all their wallet transactions and UPI payments from a single account, simplifying their financial management; (b) enhanced security: separate security credentials and centralized transaction tracking enhance security and reduce the risk of unauthorized access and/or fraud; (c) convenience: with a unique RTP ID generated for the UWLA, users can initiate transactions directly from their bank account without the need to first transfer funds to external wallets; (d) comprehensive transaction history: having all transaction records consolidated within the UWLA provides users with a comprehensive overview of their spending habits and financial activities; and (e) improved financial control: users can set spending limits, monitor transactions in real-time, and maintain better control over their finances with the UWLA. The UWLA offers a secure, convenient, and efficient solution for managing payment transactions such as real-time payment (RTP) transactions and linked digital wallets, providing users with greater control and peace of mind in their financial dealings.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers, without limitation. Each type of transactions card can be used as a method of payment for performing a transaction.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, “machine learning” (also referred to as ML) refers to statistical techniques to give computer systems the ability to “learn” (e.g., progressively improve performance on a specific task) with data, without being explicitly programmed for that specific task. The terms “neural network” (NN) and “artificial neural network” (ANN), used interchangeably herein, refer to a type of machine learning in which a network of nodes and edges is constructed that can be used to predict a set of outputs given a set of inputs.

In one embodiment, a computer program is provided, and the program is embodied on a computer readable medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of AT&T located in New York, New York). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

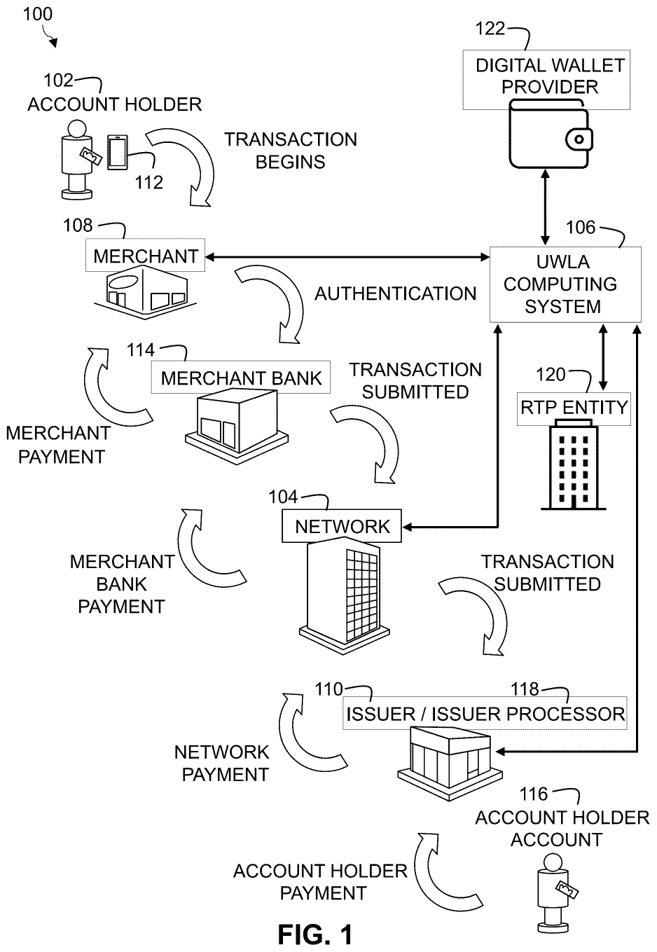

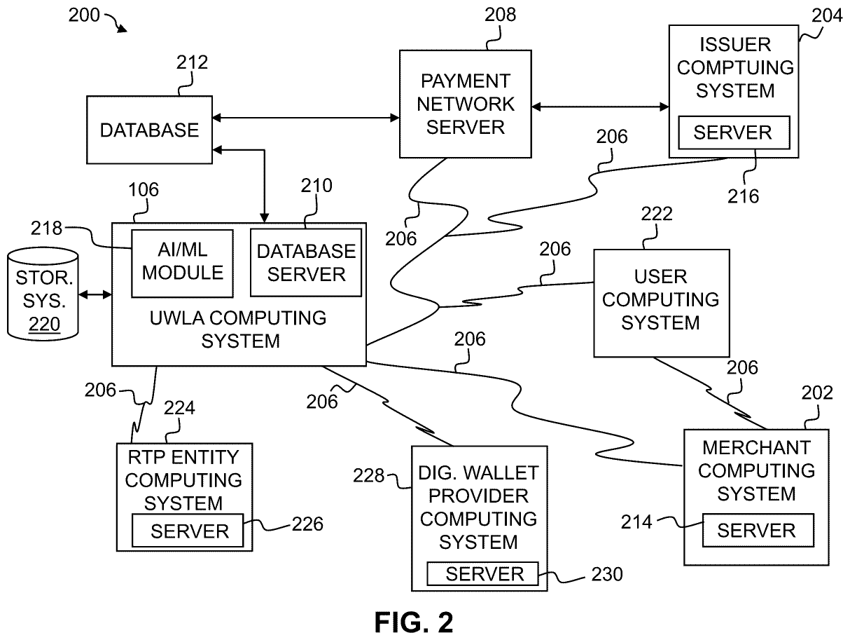

FIG. 1 illustrates a schematic diagram of an example multi-party payment account system 100 for enabling payment transactions initiated by account holders 102 (e.g., also referred to as users, customers, and/or purchasers) over a payment processing network 104 that is in communication and used in conjunction with a UWLA computing system 106. As described below in more detail, UWLA computing system 106 is configured to collect data from a merchant 108 (e.g., transaction data, operations data) and/or an issuer bank 110 (e.g., also referred to herein as issuer 110) in association with transactions made by a user. Embodiments described herein may relate to a transaction card system, such as a payment card payment system using the Mastercard interchange network and/or third party payment processing systems and networks. The Mastercard interchange network is a set of proprietary communications standards promulgated by Mastercard International Incorporated for the exchange of financial transaction data and the settlement of funds between financial institutions that are members of Mastercard International Incorporated. (Mastercard is a registered trademark of Mastercard International Incorporated located in Purchase, N.Y.). In the exemplary embodiment, UWLA computing system 106 is communicatively coupled to merchant 108, payment processing network 104, and issuer 110 (e.g., issuer bank). As used herein, merchant 108 and issuer 110 may be directly coupled to UWLA computing system 106, or may be indirectly coupled to UWLA computing system 106 through payment processing network 104.

In the example embodiment, a financial institution called the “issuer” or “issuing bank” issues an account, such as a primary savings/checking account, credit card account, a debit account, or a prepaid card account to an account holder 102, who uses the account to tender payment for a purchase from a merchant 108. In one embodiment, account holder 102 presents a payment card to merchant 108 using a user computing device (also known as card-present transactions). In another embodiment, the user does not present a physical payment device such as a payment card, and instead performs a card-not-present transaction. For example, the card-not-present transaction may be initiated via a digital wallet application, through a website or web portal, via telephone, or any other method that does not require the user to present a physical payment card to merchant 108 (e.g., via swiping or inserting the payment card). In some embodiments, using a digital wallet in-store via scanning of a symbol or code associated with the digital wallet and/or using a tap-to-pay feature of a mobile phone that is linked to a digital wallet may be considered a card-present transaction.

To accept payment with the transaction card, merchant 108 establishes an account with a financial institution that is part of the financial payment system. This financial institution is usually called the “merchant bank,” the “acquiring bank,” or the “acquirer.” In one embodiment, account holder 102 tenders payment for a purchase using a transaction card at a transaction processing device 112 (e.g., transaction device 112, e.g., a point of sale device in an in-store context, or a mobile computing device (e.g., mobile phone) or desktop/laptop computer in an at-home (e.g., online shopping) context), then merchant 108 requests authorization from a merchant bank 114 for the amount of the purchase. The request is usually performed through the use of a point-of-sale terminal or a computing device or computer app, which reads account information of account holder 102 from a magnetic stripe, a chip, barcode, or embossed characters on the transaction card (e.g., a debit card or a prepaid card) or otherwise imputed by the account holder and communicates electronically with the transaction processing computers of a merchant bank 114. Alternatively, merchant bank 114 may authorize a third party to perform transaction processing on its behalf. In this case, the point-of-sale terminal will be configured to communicate with the third party. Such a third party is usually called a “merchant processor,” an “acquiring processor,” or a “third party processor.”

In the example embodiment, merchant 108 communicates with, either directly or indirectly via processing network 104, other systems within multi-party payment account system 100 to authenticate account holder 102 before the transaction is further processed or to assist an authentication device that is part of the multi-party payment account system shown in FIG. 1 in authenticating account holder 102. For example, the same entity that provides UWLA computing system 106 may provide systems that can authenticate account holder 102 as described herein. Once account holder 102 has been authenticated, using processing network 104, computers of merchant bank 114 or merchant processor will communicate with computers of an issuer bank 110 to determine whether an account 116 of account holder 102 is in good standing and whether the purchase is covered by available funds and/or an available credit line of account holder 102. Based on these determinations, the request for authorization will be declined or accepted. If the request is accepted, an authorization code (e.g., included in an authorization message) is issued to merchant 108. An authorization message includes a transaction identifier associated with the transaction and an indicator indicating that the transaction was authorized. If the request is not accepted, authorization message includes a transaction identifier associated with the transaction and an indicator indicating that the transaction was declined. In the example embodiment, authorization message is formatted according to ISO 8583 network messaging protocol or the equivalent messaging protocol used by the payment card processing network.

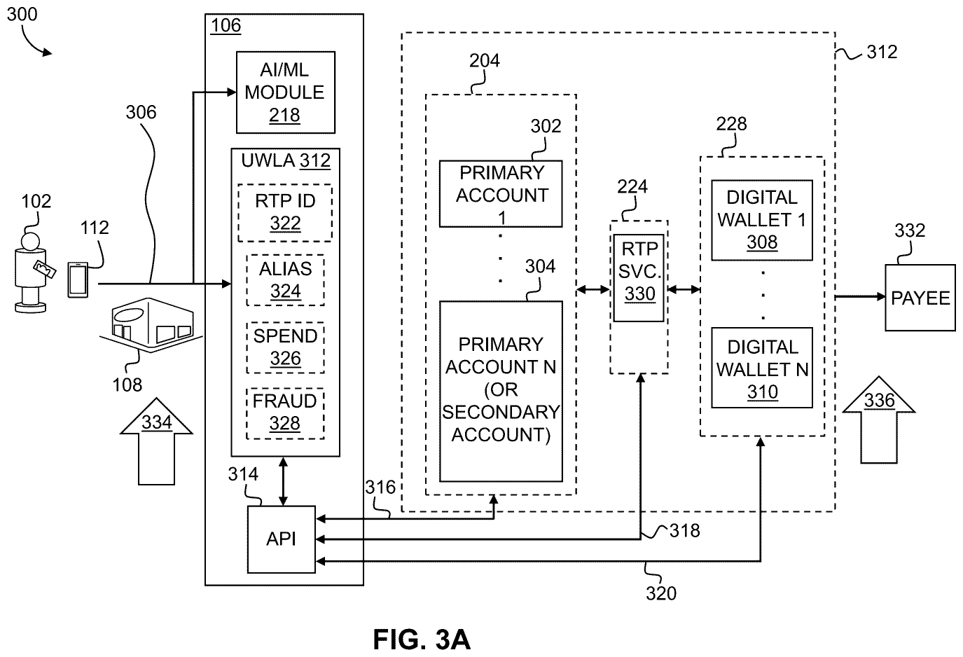

When a request for authorization is accepted, the available funds and/or other credit line of account 116 of account holder 102 is decreased. Normally, a charge for a payment card transaction is not posted immediately to account 116 of account holder 102 because certain rules do not allow merchant 108 to charge, or “capture,” a transaction until goods are shipped or services are delivered. However, with respect to at least some debit card transactions, a charge may be posted at the time of the transaction. When merchant 108 ships or delivers the goods or services, merchant 108 captures the transaction by, for example, appropriate data entry procedures on the point-of-sale terminal. This may include bundling of approved transactions daily for standard retail purchases. If account holder 102 cancels a transaction before it is captured, a “void” is generated. If account holder 102 returns goods after the transaction has been captured, a “credit” is generated. Processing network 104 and/or issuer bank 110 stores the transaction information, such as a type of merchant, amount of purchase, date of purchase, etc. in a database (e.g., database 212, shown in FIG. 2).

After a purchase has been made, a clearing process occurs to transfer additional transaction data related to the purchase among the parties to the transaction, such as merchant bank 114, processing network 104, and issuer bank 110. More specifically, during and/or after the clearing process, additional data included in a clearing message, such as a time of purchase, a merchant name, a type of merchant, purchase information, user account information, a type of transaction, a transaction identifier, information regarding the purchased item(s) (e.g., product identifiers), information regarding container(s) of the purchased item(s) (e.g., container identifiers), and/or other suitable information, is associated with a transaction and transmitted between parties to the transaction as transaction data, and may be stored by any of the parties to the transaction. In the example embodiment, the clearing message is formatted according to ISO 8583 network messaging protocol or the equivalent messaging protocol used by the payment card processing network.

After a transaction is authorized and cleared, the transaction is settled among merchant 108, merchant bank 114, and issuer bank 110. Settlement refers to the transfer of financial data or funds among account of merchant 108, merchant bank 114, and issuer bank 110 related to the transaction. Usually, transactions are captured and accumulated into a “batch,” which is settled as a group. More specifically, a transaction is typically settled between issuer bank 110 and processing network 104, and then between processing network 104 and merchant bank 114, and then between merchant bank 114 and merchant 108.

As described above, the various parties to the payment card transaction include one or more of the parties shown in FIG. 1 such as, for example, account holder 102, merchant 108, merchant bank 114, processing network 104 (also referred to herein as an interchange or an interchange network), issuer bank 110, and/or an issuer processor 118. A transaction may be referred to in a temporal manner, such a historical (e.g., past or prior) transactions, current, or live (e.g., a transaction that may be occurring at any given live moment).

UWLA computing system 106 may be in operative communication with an RTP entity 120 and a digital wallet provider(s) 122. RTP entity 120 may be an entity that provides, owns, and/or operates a payment service, such as a real-time payment service, as described herein. Digital wallet provider(s) 122 may be an entity that provides, owns, and/or operates a digital wallet service, as described herein.

FIG. 2 illustrates a schematic diagram of an example UWLA computing subsystem 200 including UWLA computing system 106 and a plurality of client sub-systems and/or other computing systems coupled to UWLA computing system 106, usable within or in communication with multi-party payment account system 100. In some embodiments, the UWLA platform described herein may be implemented as UWLA computing subsystem 200. Client sub-systems may include merchant computing system 202 of merchant 108 (also referred to as merchant computing device 202, or more generally client sub-system 202) and issuer computing system 204 of issuer 110 (also referred to as issuer computing device 204, or more generally client sub-system 204).

Client sub-systems 202 and 204 are coupled to the Internet through many interfaces including a network 206, such as a local area network (LAN) or a wide area network (WAN), dial-in-connections, cable modems, special high-speed Integrated Services Digital Network (ISDN) lines, and RDT (reliable data transfer) networks. Merchant system 202 includes systems associated with merchants 108 (shown in FIG. 1) as well as external systems used to store data. For example, merchant computing system 202 may include transaction processing device 112 (shown in FIG. 1), which may be realized as a point-of-sale (POS) computing device (also referred to as POS terminal) communicatively and operatively coupled to an external system of merchants 108, or a website used by the merchant to sell goods or services. Issuer computing system 204 includes systems associated with issuer banks 110 (shown in FIG. 1) as well as external systems used to store data. UWLA computing system 106 is also in communication with a payment network server 208 associated with processing network 104 (shown in FIG. 1) using network 206. Further, client sub-systems 202 and 204 may additionally communicate with processing network 104 using network 206. In more general terms, client sub-systems 202 and 204 could be any device capable of interconnecting to the Internet including a web-based (e.g., mobile) phone, PDA, smart devices, or any other web-based connectable equipment such as a POS terminal (e.g., an embodiment of transaction processing device 112 (shown in FIG. 1)).

A database server 210 of UWLA computing system 106 is coupled to a database 212, which contains information and data on a variety of matters. For example, database 212 may store account holder transaction data and issuer/merchant rules regarding transactions. Account holder transaction data may be processed, sorted, and/or otherwise analyzed according to a list of defined parameters (e.g., transaction type, transaction time, device on which the transaction was initiated, dollar amount of transaction, market segment of merchant and/or item purchased, payment network parameters, and any other applicable parameter relating to ways to categorize such transactions) and rules. In one embodiment, database 212 is a centralized database stored on UWLA computing system 106, where access to centralized database 212 may be controlled by rules defined within subsystem 200 to limit the display of data to authorized client users enrolled with subsystem 200. In an alternative embodiment, database 212 is stored remotely from UWLA computing system 106 and may be non-centralized. Database 212 may be a database configured to store information used by UWLA computing system 106 including, for example, historical and current transaction data, prompt data, other user data, merchant data, issuer data, and/or other applicable data. Database 212 may include a single database having separated sections or partitions, or may include multiple databases, each being separate from each other. In some embodiments, database 212 stores transaction data generated over the processing network including data relating to merchants, consumers, account holders, prospective customers, issuers, acquirers, and/or purchases made. Database 212 may include multiple storage units such as hard disks or solid state disks in a redundant array of inexpensive disks (RAID) configuration, and may include a storage area network (SAN) and/or a network attached storage (NAS) system.

Additional systems and components within subsystem 200 may include a server 214 of merchant system computing 202, a server 216 of issuer computing system 204, an artificial intelligence/machine learning (AI/ML) module 218 of UWLA computing system 106 (described in more detail herein), a storage system 220, a user computing system 222 (also referred to as a user computing device 222), an RTP entity computing system 224 of RTP entity 120 including a server 226, and a digital wallet provider computing system 228 of digital wallet provider 122, including a server 230. Systems 224 and 226 (should this be 228 instead of 226) may be referred to as client sub-systems in a manner the same as or similar to systems 202 and 204. Server 214 may be configured to provide access to resources, data, services, and/or programs to other computers of merchants 108 over network 206. Server 216 may be configured to provide access to resources, data, services, and/or programs to other computers of issuers 110 over network 206.

AI/ML module 218 may be configured to assist with providing insight into transactions including spend and fraud aspects of transactions as performed by UWLA computing system 106, by learning transaction and calculation patterns over time via one or more models. Storage system 220 may include one or more storage devices used in conjunction with UWLA computing system 106, and may store therein both historical (e.g., training) data for training a model of AI/ML module 218, as well as newer transaction data and other data and information used to update intelligence-based rules and/or algorithms of AI/ML module 218, for use in association with the analysis performed by UWLA computing system 106. User computing system 222 (also referred to as a user computing device 222) may include a personal computing device such as a smartphone, tablet, personal computer (desktop or laptop), and the like, and may be configured and implemented as transaction device 112 in certain scenarios (such as when using a personal mobile device to pay instead of a physical card). RTP entity computing system 224 may include a system of an RTP entity 120 that provides a payment service (such as a real-time payment service) as described herein. Server 226 of RTP entity computing system 224 may be configured to provide access to resources, data, services, and/or programs to other computers of an RTP entity 120 over network 206. Digital wallet computing system 228 may include a system of a digital wallet entity 122 that provides a digital wallet service as described herein. Server 230 of digital wallet computing system 228 may be configured to provide access to resources, data, services, and/or programs to other computers of a digital wallet entity 122 over network 206.

In one embodiment, storage system 220 may be integrated with UWLA computing system 106. In other embodiments, storage system 220 may be integrated with database 212, or any other storage or database within subsystem 200. The model of AI/ML module 218 may be trained on transaction and/or other user data to be able to better recognize and categorize new transactions, determine fraudulent transactions, and/or assist with other related calculations and other procedures. While AI/ML module 218 is shown in FIG. 2 as being integrated within UWLA computing system 106, it may also be separate from (but still operatively coupled to) UWLA computing system 106. RTP entity computing system 224 and/or digital wallet provider computing system 228 may each include a computing system separate from but operatively coupled to UWLA computing system 106 that is accessible by the components of subsystem 200 for tasks performed by UWLA computing system 106, described herein in more detail.

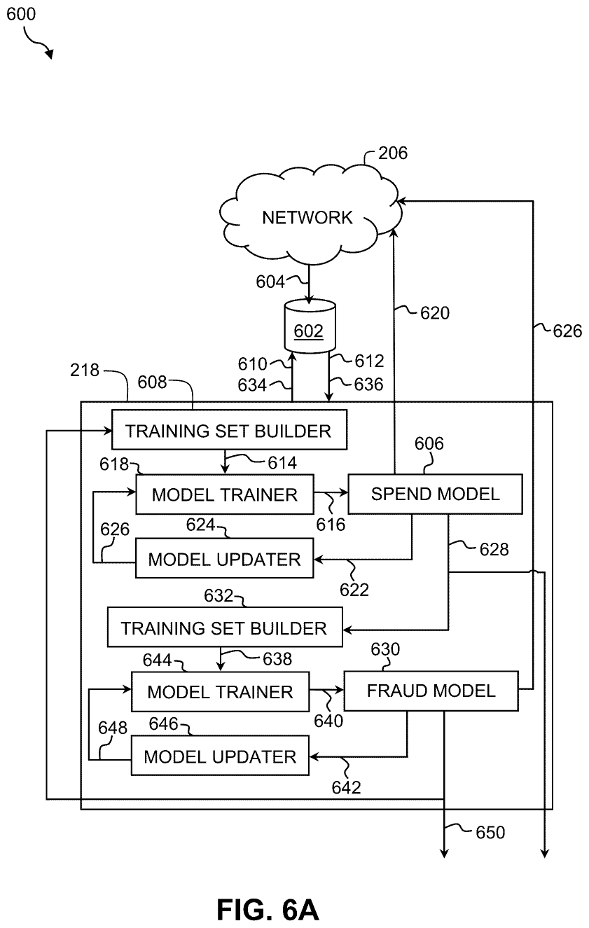

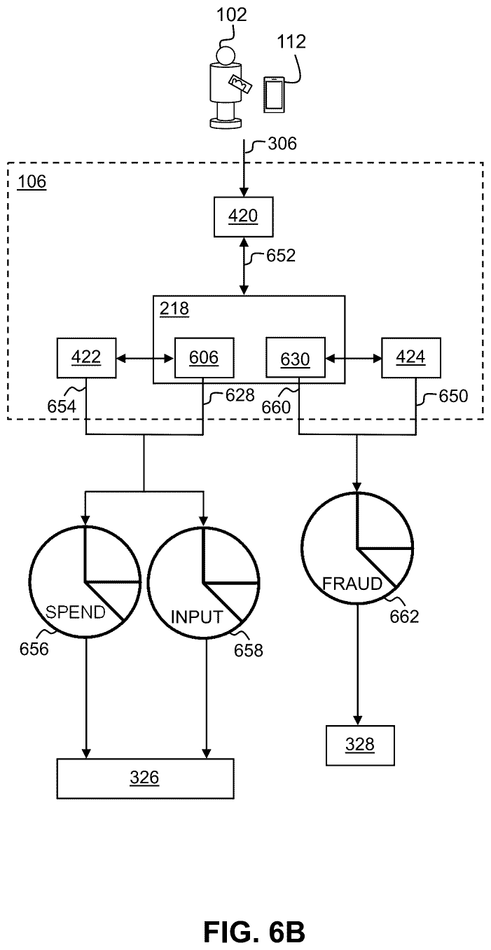

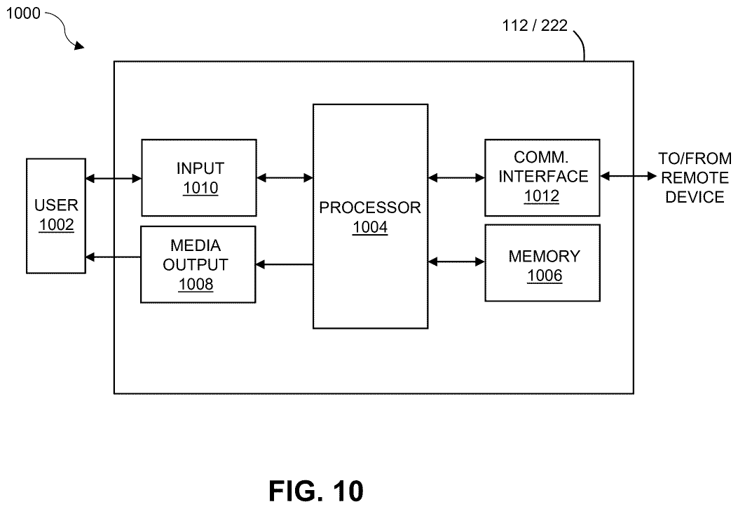

In some embodiments, user computing device 222 may be a computing device belonging to a provider of the UWLA platform and/or each UWLA, and used in conjunction with UWLA computing system 106 within subsystem 200. In such a case, a user (e.g., user 1002, shown in FIG. 10) may review outputs from UWLA computing system 106, which may include outputs (e.g., 628 and 650 from AI/ML module 218, as shown in FIG. 6A). User computing device 222 may include a server (not shown) configured to provide access to resources, data, services, and/or programs to other computers. For example, a user (e.g., such as user 1002) may be an employee of the entity that provides, owns, and/or operates UWLA subsystem 200. In this regard, outputs 628 and 650 may output results from calculations and other processes performed by UWLA computing system 106 in a user-readable format for presentation to the user 1002, so that the user 1002 may analyze the results (e.g., for purposes of verifying the accuracy of the spend and/or fraud predictions and/or models from model modules 606 and 630, such as for updating the models, etc.).

The machine learning models may utilize user patterns to detect spending and/or anomalous activity in real-time, for example for use in transaction analysis and fraud detection. A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs. Additionally or alternatively, the machine learning programs may be trained by inputting sample data sets or certain data into the programs, such as transaction data, network messages (e.g., ISO 8583 messages), and/or other internal data regarding transactions. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing - either individually or in combination, for use, for example, in generating outputs for human consumption. The machine learning programs may also include natural language processing, semantic analysis, automatic reasoning, and/or (supervised) machine learning. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

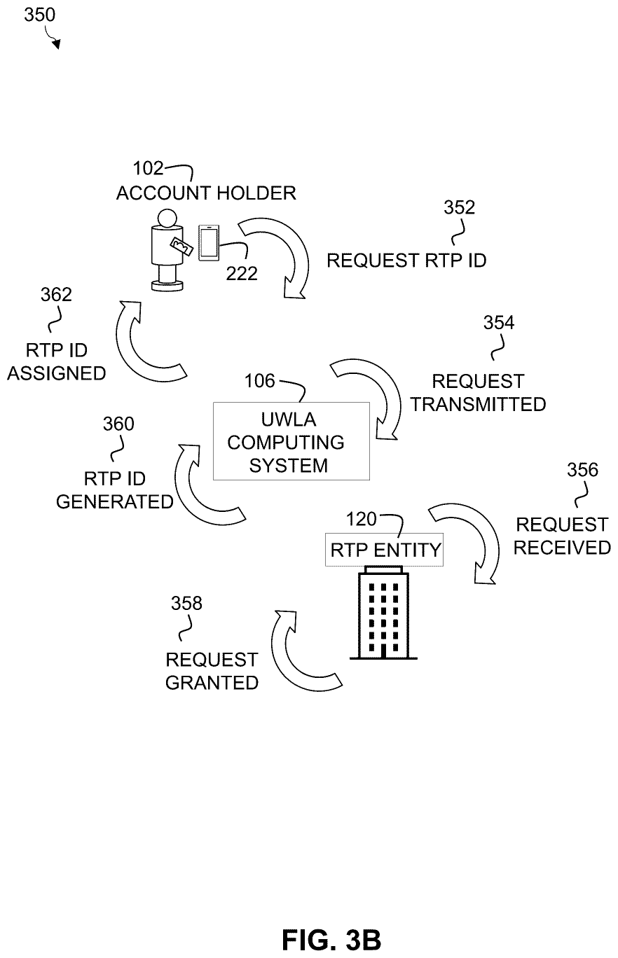

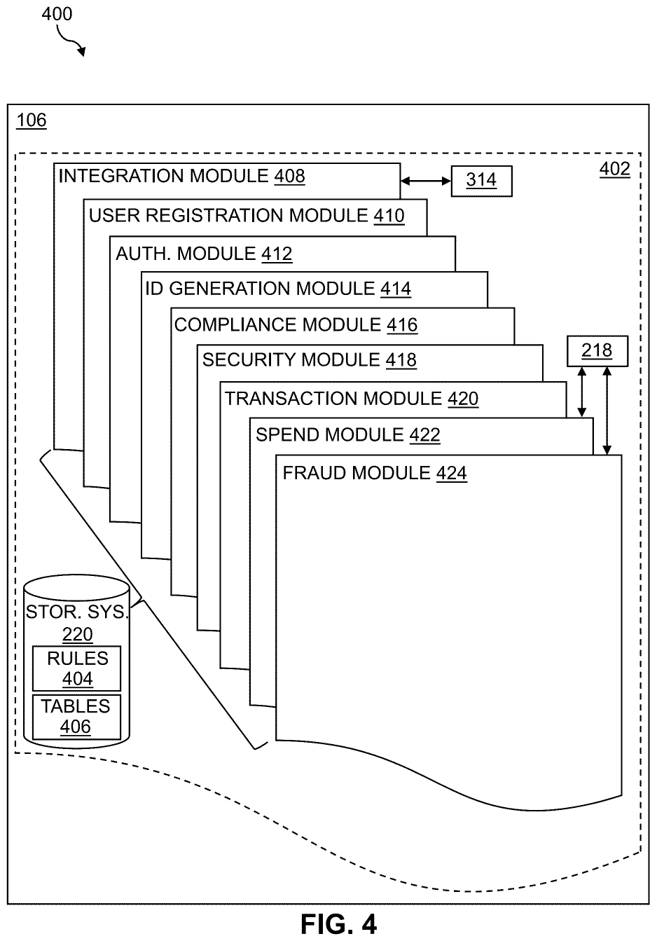

FIG. 3A illustrates an example process flow 300 for transactions within subsystem 200 according to one embodiment of the present disclosure. Account holder 102 may have one or more bank accounts, including a first primary account 302, and one or more (e.g., “N”) other primary accounts 304 (which may alternatively be referred to as secondary accounts). Account holder 102, via a device such as transaction device 112, may make one or more transactions 306 at a merchant 108. Account holder 102 may have other accounts such as digital wallets 308, 310 that are linked to accounts 302/304, and are intended to be used for transactions 306. Digital wallet 308 may be a first or primary digital wallet and digital wallet 310 may be one or more (e.g., “N”) different digital wallets. Accounts such as 302/304 and digital wallets 308/310 may have already been opened by account holder 102 before opening a UWLA. In FIG. 3A, account holder 102 has opened a UWLA 312, and UWLA 312 has been setup to interface with accounts 302/304 and/or digital wallets 308/310. UWLA computing system 106 may be integrated with accounts 302/304 and/or digital wallets 308/310 by way of one or more APIs via API module 314. API module 314 may include one or more banking account APIs 316 for linking accounts 302/304 associated with one or more issuer banks 110 to UWLA computing system 106, and more specifically to interface UWLA 312 with accounts 302/304.

API module 314 may also include one or more RTP entity APIs 318 associated with RTP entity 120, for example used in connection with creating an RTP ID for UWLA 312. API module 314 may further include one or more digital wallet APIs 320 for linking digital wallets 308/310 associated with one or more digital wallet providers 122 to UWLA computing system 106. Implementation of APIs 316, 318, and 320 for communication between UWLA computing system 106 and linked accounts 302/304, linked digital wallets 308/310, and/or RTP entity 120 may include transaction processing logic to deduct funds from UWLA 312 for digital wallet transactions. UWLA 312 may be assigned an RTP ID 322 that may be used in conjunction with an alias 324, as described herein. UWLA computing system 106 may communicate and interface with merchant computing system 202, issuer computing system 204, RTP entity computing system 224, and/or digital wallet provider system 228 in the manner shown and described in connection with FIG. 2 for purposes of operating UWLA 312. In other embodiments, transaction device 112 may be a mobile phone of the user and used for online purchases.

RTP ID 322 may be generated upon the creation of UWLA 312 using unique identifier generation algorithms to generate RTP IDs that are compliant with requirements of RTP entity 120. UWLA 312 may establish alias 324 associated with a user/account holder to further insulate UWLA 312 from other account holder accounts, as alias 324 may be used in place of other sensitive user information for purposes of authentication/verification. UWLA 312 may, for each of RTP ID 322 and/or each digital wallet 308/310, be configured to utilize and implement tokenization instead of using an actual account number, as described herein.

UWLA computing system 106 may further include AI/ML module 218 which is configured to interface with various other systems such as merchant computing system 202 shown in FIG. 2 so that transactions 306 may be tracked and to learn about the spend and/or other financial patterns of account holder 102, for establishing a spend profile 326 for account holder 102. Such transaction data may additionally be utilized for fraud detection/protection aspects and to build a fraud profile 328 for account holder 102, as described herein. The transaction device 112 may be configured to send the tokenized information to a payment processor (e.g., 118 shown in FIG. 1), which then communicates with issuer 110 to authorize the transaction. The issuer/issuer processor then verifies the token and processes the payment. RTP ID 322 may be set and utilized in conjunction with RTP service 330 of RTP entity 120, where RTP service 330 may be a real-time payment service as described herein. Payee 332, which in this case may be a merchant 108, may then be paid by account holder 102 via funds transfer from UWLA 312. Spend profile 326 may be individualized for each user and may include information pertaining to personalized spending and/or input parameters, which may be determined and set in conjunction with AI/ML module 218. Fraud profile 328 may be individualized for each user and may include information pertaining to personalized fraud risk and/or fraud parameters, which may be determined and set in conjunction with AI/ML module 218. Due to the relation between a user's spend and the amount of funds needed in their UWLA (e.g., UWLA 312), spend profile 326 may also function as a funding profile for storing input parameters of the user.

In some embodiments, accounts 302/304 may be associated with one or more banks such as issuer 110 shown in FIG. 1. RTP ID 322 may be associated with an RTP entity 120 as shown in FIG. 1. Digital wallets 308/310 may be associated with one or more digital wallet provider(s) 122 shown in FIG. 1. UWLA 312 may be associated with the same entity associated with one or accounts 302/304. For example, the bank that account 302 exists at may be the same bank that UWLA 312 exists at. Alternatively, digital wallets 308/310 may not be used, and funds for transactions 306 may be processed directly from accounts 302/304 via UWLA computing system 106. In other embodiments, payee 332 may be an entity other than a merchant.

In some embodiments, each of UWLA computing system 106, accounts 302/304, and digital wallets 308/310 may be configured within or otherwise in operative communication with issuer computing system 204. API module 314 may include one or more APIs such as APIs 316, 318, and/or 320 for integrating and/or otherwise linking UWLA computing system 106 to issuer computing system 204, RTP entity computing system 224, and/or digital wallet provider computing system 228. While UWLA 312 is shown in FIG. 3A as being one UWLA for a plurality of accounts 302/304 and digital wallets 308/310, there may be a plurality of UWLAs 312, such as one UWLA 312 for each account 302, 304 and each digital wallet 308, 310.

In some embodiments, accounts 302, 304 may be credit accounts associated with a credit card provider and corresponding credit card(s), and digital wallets 308, 310 may be linked to the credit cards. In other embodiments, accounts 302 and 304 may be a mix of bank accounts and credit accounts. UWLA 312 may be setup by account holder 102 at a bank such as issuer bank 110 shown in FIG. 1, or with a different bank, or with a dedicated other entity that owns, runs, and/or operates UWLA computing system 106 and handles creation of UWLAs such as UWLA 312. As such, while FIG. 3A illustrates API module 314 interfacing with issuer bank 110, RTP entity 120, and digital wallet providers 122, this is not limiting and other entities may be utilized.

In some embodiments, tokenization, such as in connection with RTP ID 322, may be configured to be implemented via a hash function (e.g., a mathematical algorithm) that takes an input and returns a fixed-size string of bytes. The output (e.g., hash value) is deterministic. Hash functions including but not limited to SHA-256, SHA-3, and MD5 may be implemented for tokenization of RTP ID 322. For example, when a token is generated (e.g., for authentication or transaction purposes), the token may include information such as user ID, timestamp, and/or some other random or unique identifier such as RTP ID 322. Such information may be concatenated into a single string, which serves as the input for the hash function. The concatenated string is fed into the hash function, which processes the input through a series of operations, including but not limited to bitwise operations, modular arithmetic, and/or compression functions. Tokenization may occur at various stages of the transaction process but not limited to stages 334 and 336.

Configuring UWLA 312 as a standalone dedicated account provides enhanced security, convenience, and user-centric design. By way of the centralized and secure design of UWLA 312, and the manner in which UWLA 312 is isolated from associated accounts such as accounts 302/304 and/or digital wallets 308/310, UWLA 312 provides users with a dedicated account separate from their primary (e.g., bank) accounts and improves security, including improved fraud detection. For example, UWLA 312 is at least isolated from accounts 302/304 by virtue of RTP ID 322 and/or alias 324. Digital wallets 308/310 and/or RTP service 330 may be referred to herein as external payment services. Accounts 302/304 may be referred to herein as funding accounts.

By way of the transaction management and tracking functionality of UWLA 312, combined with the AI/ML-based function provided by AI/ML module 218, UWLA 312 streamlines transaction management, provides users with greater control over their financial activities, and assists users with learning their individualized financial behaviors patterns such as spend patterns. Users realize the benefits of UWLA 312 via the funds in UWLA 312 being set and managed on an “as needed” basis via behavior learned from AL/ML module 218, avoiding undesired and/or unnecessary amounts of funds in UWLA 312, reduced frequency of manually accessing user banking accounts, and reducing and/or avoiding use of sensitive financial information such PANs. For example, AI/ML module 218 may learn over time that a user spends $4,000 USD at the beginning of every month on rent and other bills. AI/ML module 218 may define spending parameters for the user based on such learned spending behavior. Such spending parameters may include partitioning the spend data into various categories such as housing (e.g., rent), bills (e.g., student loans), utilities (e.g., power, water), necessities (e.g., food/grocery), and the like.

FIG. 3B illustrates an example process flow 350 of an RTP ID issuance process. An account holder 102 may request 352 an RTP ID for their UWLA, where such request may be made via user computing device 222. UWLA computing system 106 transmits 354 such request to RTP entity 120. RTP entity 120 receives (and reviews) 356 the request, and if proper grants 358 the request. Upon receipt of the granted request, UWLA computing system 106 generates 360 an RTP ID and assigns 362 the generated RTP ID to the UWLA as described herein. With reference to FIG. 2, this RTP ID issuance process may be performed via respective systems and components including UWLA computing system 106, RTP entity computing system 224, and network 206, for example. With reference to FIG. 3A, an RTP ID such as RTP ID 322 may be linked to a UWLA such as UWLA 312 and/or other accounts within UWLA 312 such as digital wallets 308/310.

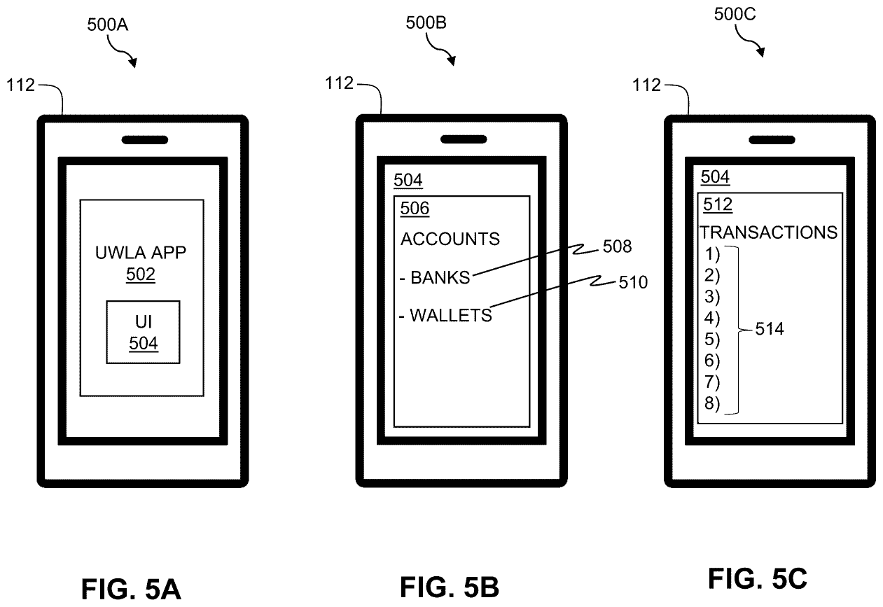

FIG. 4 illustrates an example configuration 400 of UWLA computing system 106 including a system backend 402 including an integration module, a user registration module, an authorization and authentication module (referred to herein as “auth. module”), an ID generation module (e.g., an RTP ID generation module), a compliance module, a security module, a transaction module, a spend module, and a fraud module. In one embodiment, backend 402 includes storage system 220 shown in FIG. 2, and storage system 220 has stored therein a plurality of rules 404 and/or tables 406 associated with the various modules. Storage system 220 may be configured as one or more databases, one or more storage media, or any combination thereof, local or cloud-based.

Integration module 408 may be configured and implemented to integrate UWLA computing system 106 with the various other systems and components shown in FIGS. 1 and 2. For example, integration module 408 may include therein or otherwise be in operative communication with API module 314 as described herein, and all other applicable components (e.g., hardware and software) to enable backend communications and processes to occur within system 100 and subsystem 200 to implement process flows 300 and 350.

User registration module 410 may be configured and implemented to perform aspects of an account creation process for the creation of UWLA 312, including but not limited to information intake and data population using tables with necessary fields therein for listing personal information of a user such as account holder 102. Tables for user registration module 410 may be part of tables 406 stored within storage system 220. User registration module 410 may be integrated with various backend systems for user account creation and management. User registration module 410 may include there account creation rules, which may be stored as part of rules 404 within storage system 220.

Auth. module 412 may be configured and implemented to perform validation and verification processes for user identification as described herein. For example, auth. module 412 may include therein authorization and authentication rules for authorizing and authenticating a user. The authorization and authentication rules may be stored as part of rules 404 within storage system 220.

ID generation module 414 may be configured and implemented to generate unique identifiers such as RTP ID 322 shown in FIG. 3A in connection with RTP service 330 provided by RTP entity 120. This may include implementation of an RTP ID generation algorithm, and integration with a bank's core banking system (such as issuer computing system 204) to assign and manage unique RTP IDs for each UWLA 312. ID generation module 414 may be used in conjunction with auth. module 412 to ensure that any generated RTP ID is linked to a properly authorized and authenticated user. In some embodiments, the RTP ID generation algorithm may be configured to utilize formats based on a 10-15 digit alphanumeric code, including but not limited to “abcde12345@bankname”, and/or other formats set by RTP entity 120.

Compliance module 416 may be configured and implemented to ensuring compliance with RTP entity specifications and standards for RTP ID generation, as well as compliance with relevant banking regulations and other RTP entity guidelines. Corresponding regulatory rules may be stored as part of rules 404 within storage system 220. Compliance module 416 may also be configured and implemented to conduct regular audits and assessments to maintain compliance with data security and privacy standards. Establishing the operational parameters of compliance module 416 may include collaboration with regulatory bodies and/or other industry associations.

Security module 418 may be configured and implemented to provide secure authentication mechanisms as described herein (e.g., OAuth) for authorization and access control, which may include implementation of strong encryption protocols to secure user data and transactions. Security module 418 may also be configured to integrate with authentication systems for user access control (e.g., two-factor authentication) and implemented as part of fraud detection algorithms to identify and mitigate suspicious activities.

Transaction module 420 may be configured and implemented to integrate with banking and/or RTP entity infrastructure and systems (such as computing systems 204, 224) for processing transactions. Such integration may be by way of API module 314 for communication between UWLA 312 and linked accounts 302/304, digital wallets 308/310, and RTP service 330, and may include transaction processing logic to deduct funds from UWLA 312 for digital wallet transactions. Such transaction processing logic may include transaction tracking, and a transaction database for storing transaction data associated with each UWLA 312, and may be implemented as part of AI/ML module 218. The transaction database may be implemented as a part of storage system 220. Transaction data may be logged and tracked to record all transactions initiated through linked accounts 302/304 and/or digital wallets 308/310. Transaction module 420 may include reporting and querying functionalities, which may be implemented in a front-facing manner so that users can view their transaction history. Transaction module 420 may store various transaction data within corresponding tables of tables 406. Transaction module 420 may operate based on intelligence-based rules stored within rules 404.

Spend module 422 may be an individual module, and/or integrated within transaction module 420, and may be configured and implemented to generate corresponding user spending parameters. This may be done in conjunction with AI/ML module 218, for example, or other intelligence-based rules. Spend module 422 may also function to fund UWLA 312 with a predicted amount of funds drawn from linked accounts such as accounts 302/304. For example, using historical transaction data, spend module 422 may automatically trigger funds transfer into UWLA 312 so that UWLA 312 always has funds sufficient for the user's needs. This may vary weekly, monthly, and/or seasonally. In some embodiments, spend module 422 may be configured to implement an AI-based spend model as shown in and described in connection with FIG. 6A, and/or perform operations on an output of such a model. Due to the relationship between spending and funding, spend module 422 may also be configured to generate input parameters. For example, spend module 422, via AI/ML module 218, may learn that a user a certain fixed expenses every month, as well as certain periodic expenses, and adjust the amount of funds within UWLA 312 accordingly based on such learned input parameters. Input parameters may be determined and/or otherwise based on time aspects (e.g., weekly, monthly, or other frequencies), particular seasons (e.g., spring, summer, holiday seasons), income (e.g., when a user receives a deposit from their employer), types and amounts of expenses/payments made (e.g., to merchants, to utility companies, rent/mortgage, insurance, etc.), and the like. In one implementation of input parameters, AI/ML module 218 may learn that a user needs at least $4,000 USD in their UWLA on the first day of each month to pay for rent and other bills. AI/ML module 218 may detect that the user had higher than average expenses at the end of the prior month, and therefore the funds in the UWLA are lower than $4,000. In order to ensure that the UWLA has $4,000 in it by the first day of the month, AI/ML module may communicate to integration module 408 that additional funds need to be pulled from a linked account such as account 302 so that the UWLA has the necessary funds (e.g., $4,000). Additionally, or alternatively, a user may set limits of their UWLA so that a designated minimum or maximum amount of funds are available. For example, a user may set a minimum UWLA balance threshold of $1,000. If the amount available in the UWLA falls below $1,000 during any given time period, spend module 422 may be configured to automatically reload the UWLA back to the $1,000 threshold value. Determinations and/or other outputs and data from spend module 422 may be utilized in conjunction with defining spend profile 326. Spend module 422 may operate based on intelligence-based rules stored within rules 404 in addition to AI-based parameters resulting from AI/ML module 218.

Fraud module 424 may be an individual module, and/or integrated within transaction module 420, and may be configured and implemented to generate corresponding user fraud parameters based, for example, on a user's spend and transaction behavior relative to detecting fraudulent spending/transaction activity. This may be done in conjunction with AI/ML module 218 and/or spend module 422, for example, or other intelligence-based rules, as well as in conjunction with security module 418. Fraud module 424 may be configured to analyze historical data, such as via AI/ML module 218, to learn user spend and transaction patterns and determine what constitutes a valid transaction as compared to a potentially fraudulent transaction, for example as part of performing operations on an output of fraud model module 630. This learned knowledge may be used to form and define fraud parameters for users. Fraud parameters may include any spend and/or other transaction data that may assist in building fraud profile 328 and used to detect potential fraud. Fraud parameters may include information pertaining to normal purchase amounts, normal purchase times/locations/frequencies, and likewise abnormally high-dollar purchases, and/or purchases with abnormal frequency, time, and/or location, and the like. Such fraud detection may be complemented by fraud protection aspects, where UWLA computing system 106 may generate notices or other warnings to the user in connection with suspicious activity. Fraud module 424 may be configured to implement an AI-based fraud model as shown in and described in connection with FIG. 6A. Determinations and/or other outputs and data from fraud module 424 may be utilized in conjunction with defining fraud profile 328. Fraud module 424 may operate based on intelligence-based rules stored within rules 404 in addition to AI-based parameters resulting from AI/ML module 218.

The various modules shown in FIG. 4 may function as follows in connection with the creation of UWLA 312 and/or processing of transactions. Account holder 102 (shown in FIG. 1) may visit a bank or use a bank's website or mobile app to create an account. From the account creation process as performed by integration module 408 and user registration module 410, an identifier such as an email address, and/or mobile number of account holder 102 may be registered with the bank and verified by fetching, via the bank's server (e.g., 216 shown in FIG. 2) user information and/or other account details of account holder 102 that are linked to the verified mobile number. Along the way, communications may be secured via encryption, where all communication between the bank's server (e.g., 216) and other systems is encrypted using industry protocols including but not limited to transport layer security (“TLS”) to ensure data security. The user may create an alias (e.g., 324 shown in FIG. 3A) including but not limited to a Virtual Payment Address (VPA). Alias 324 may take the form of an email address of the format username@bankname or similar. RTP ID 322 may also a VPA or similar in form and function as a VPA. Any modules described herein may utilize any combination of database 212, storage system 220, and/or table 406 for data handling purposes.

ID generation module 416 may be configured to perform setup of RTP ID 322, in which an ID (e.g., username@bankname) is generated, and securely stored and encrypted. RTP ID 322 is required for authorizing transactions. System 224 of RTP entity 120 may leverage real-time payment infrastructure, including but not limited to the Immediate Payment Service (IMPS) infrastructure for real-time fund transfers.

Integration module 408 may further be configured to provide backend integration with the systems of RTP entity 120 (e.g., system 224 shown in FIG. 2) and/or digital wallet providers 122 (e.g., system 228 shown in FIG. 2). As shown in FIG. 1, these various systems may function as intermediaries between the user's bank (e.g., 110) and the recipient's (e.g. merchant 108) bank (e.g., 114). This may include providing functionality for ongoing transfers of funds between linked accounts such as account 302 and UWLA 312, to ensure that UWLA 312 is always properly funded. For example, integration module 408 may, in conjunction with AI/ML module 218, be configured to pull funds from account 302 to transfer to and fund UWLA 312.

Transaction module 420 may be configured to process transactions 306 shown in FIG. 3A. This may include processing the initiation and authorization of transactions, as well as the funds transfer for settling transactions. When the user initiates a transaction, the transaction details including but not limited to the transaction amount, merchant name, etc. may be sent by merchant bank 114 to issuer bank 110 via payment processing network 104 as shown in FIG. 1. Merchant bank 114 may forward the transaction request to the user's bank (e.g., issuer bank 110) for authorization. The user may then enter their RTP ID 322 and/or alias 324 to authorize the transaction. Upon successful authorization, the user's bank (e.g., bank 110) debits the amount and merchant bank 114 credits it to the recipient's (e.g., merchant 108) bank account.

Transaction module 420 may further be configured to transmit confirmation and notification messages, both on the backend (e.g., in the form of ISO-8583 messages), and front-facing user-readable messages to the user and/or merchant (e.g., 108). Both the sender (e.g., user/account holder 102) and recipient (e.g., merchant 108) may receive a confirmation message once the transaction is complete. UWLA computing system 106 and the corresponding banks (e.g., 110, 114) may maintain logs of all transactions for audit and compliance purposes. Within UWLA computing system 106, such logs may be stored in storage system 220.

Modules such as auth. module 412, compliance module 416, security module 418, spend module 422, and fraud module 424 may operate in conjunction with the other modules at various points of the account opening and/or transaction processing stages. For example, auth. module 412, compliance module 416, and security module 418 may all be configured to be utilized during account opening for providing authorization/authentication, security, and/or compliance checks as described herein. Spend module 422 and fraud module 424 may be configured as “baked in” functions that constantly run and are updated for each and every transaction to learn user spend patterns and to better detect fraud (e.g., such as spend that does not match with a user's spending patterns). The spending patterns may be defined as spending parameters used in conjunction with transaction module 420, spend module 422, AI/ML module 218, and/or spend profile 326.

In one embodiment, ID generation module 414 may be configured to perform tokenization in connection with RTP ID 322. In other embodiments, transaction module 420, alone or in conjunction with ID generation module 414, may be configured to perform tokenization in connection with RTP ID 322.

Each module described herein may comprise computer code and/or other software and/or hardware components as part of UWLA computing system 106, and may be configured to interface with one another for operation of UWLA computing system 106. In some embodiments, each module may comprise computer code and/or other software and/or hardware components as part of backend 402 of UWLA computing system 106. The data, tables, etc. stored within modules 408-426, for example, may be stored in a respective storage device for each module, and/or in a centralized storage device such as storage system 220 shown in FIG. 2, which may be local to UWLA computing system 106 or cloud-based, for example.

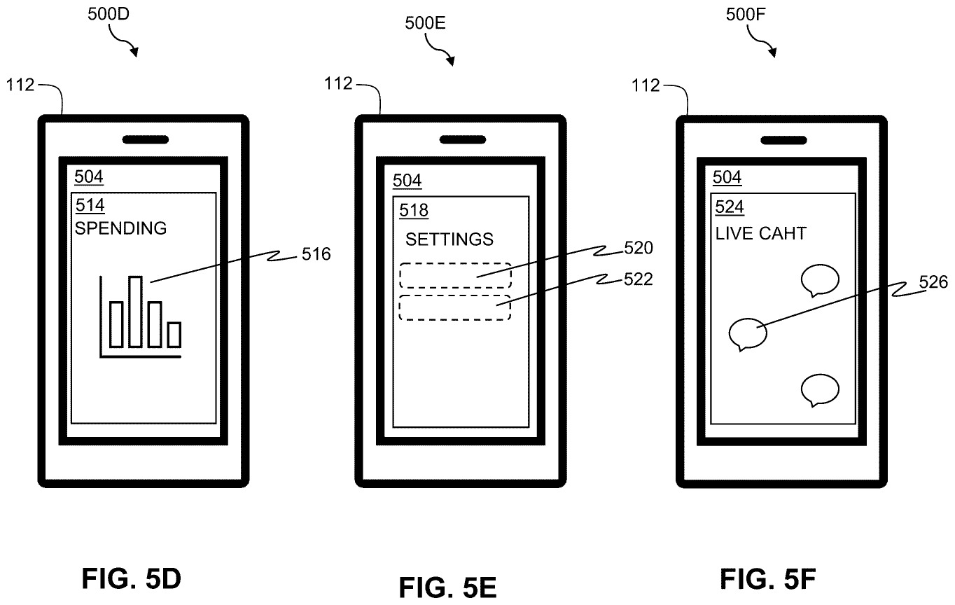

FIGS. 5A to 5F illustrate an embodiment of a front-facing interface design for UWLA 312 in the form of a mobile device application (e.g., app). Interface 500A shown in FIG. 5A illustrates UWLA app 502 on a transaction processing device 112 embodied as a mobile device (such as personal computing device 222). UWLA app 502 includes a user interface (UI) 504 for a user to navigate and use UWLA app 502. FIG. 5B illustrates that UI 504 may include an “Accounts” interface 506 listing accounts 508 and 510 that UWLA 312 is associated. Accounts 508 may include banking accounts such as accounts 302/304. Accounts 510 may include digital wallet accounts including accounts 308/310, as shown in FIG. 3A. Interface 500C, shown in FIG. 5C illustrates a “Transactions” interface 512, which may list one or more recent transactions 514, for example in chronological order. There may be sort and/or filter functionality allowing a user to sort/filter transactions according to certain thresholds (e.g., amount, date, category, etc.). FIG. 5D illustrates a “Spending” interface 514 which may display spending patterns for a given time frame, and/or sorted by merchant, category, account, and the like, and which may be accompanied by a visual graphic 516 such as a graph and/or chart for presentation of such data to the user. Graphic 516 may display spending parameters such as spend within certain categories including bills, utilities, necessities, and the like. FIG. 5E illustrates a “Settings” interface 518, which may allow a user to adjust one or more settings 520, 524, such as pin, password, email, set spending limits, and the like. For example, as described herein, if a user desires to set a $1,000 minimum funding amount so that their UWLA always has $1,000 in it at any given moment, a user may use “Settings” interface 518 to set such limits. FIG. 5F illustrates a “Live Chat” interface 524 which may provide a live chat function 526 to users with questions regarding their account or the service. By providing an app such as UWLA app 502, users can have access to customer support tools (e.g., live chat) for handling user inquiries and support requests. Moreover, UWLA app 502 functions as a one-stop shop for a plurality of user needs relating to their UWLA 312. UWLA app 502 may provide users with improved financial control, enabling users to set spending limits, monitor transactions in real-time, and maintain better control over their finances with UWLA 312. UWLA app 502 may further provide users with a comprehensive overview of their financial activities, granting access to transaction history, detailed transaction records, and the ability to monitor spending patterns in real-time. In one embodiment, account holder 102 utilizes UWLA app 502 to request an RTP ID such as RTP ID 322 in the manner shown in and described in connection with FIGS. 3A and 3B in conjunction with ID generation module 414.

FIG. 6A is a schematic diagram 600 illustrating further detail of exemplary AI/ML module 218 (shown in FIG. 2). AI/ML module 218 may be in operative communication with other components of subsystem 200, such as database server 208 (or a third-party server), client systems 204 via network 206 (shown in FIG. 2), etc. AI/ML module 218 may include and/or be in communication with a database 602 that stores data 604 including transaction data. Data 604 received from network 206 may be stored in database 602. AI/ML module 218 may be configured to use data 604 to (i) generate a spend model module 606 for generating and providing a spend model for controlling certain operations of AI/ML module 218, (ii) detect and/or predict fraudulent transactions, and/or (iii) generate action recommendations in response to operational requests, and the like. Database 602 may be a dedicated database for AI/ML module 218, local or cloud-based, and may be the same as, similar to, or part of storage system 220 shown in FIG. 2. Spend model module 606 may be integrated within or otherwise in operative communication with spend module 422 shown in FIG. 4. Due to the relation between a user's spend and the amount of funds needed in their UWLA, spend model module 606 may also function as a funding model module for determining input parameters of the user.

In exemplary embodiments, AI/ML module 218 includes a training set builder module 608 configured to submit one or more queries 610 to database 602 to retrieve subsets 612 of data 604, and to use those subsets 612 to build training data sets 614 for generating the spend model via the machine-learning spend model module 606. For example, query 610 may be configured to retrieve certain fields from data 404 for historical claims sharing characteristics, transactions originated by certain POS or merchants, transaction history for a customer, and the like.

In exemplary embodiments, training set builder module 608 may be configured to derive training data sets 614 from retrieved subsets 612. Each training data set 614 corresponds to a historical data 604 (“historical” in this context means completed in the past, as opposed to completed in real-time with respect to the time of retrieval by training set builder module 608). Each training data set 614 may include “model input” data fields along with at least one “result” data field representing a historical outcome associated with the model input. The model input data fields represent factors that may be expected to, or unexpectedly be found during model training to, have some correlation.

In exemplary embodiments, the model input data fields in training data sets 614 may be generated from data fields in subset 612 corresponding to historical data 604. In other words, a trained machine learning model 616 produced by a model trainer module 618 for use by spend model module 606 is trained to make predictions based on input values that can be generated from the data fields in data 604. Values in the model input data fields may include values copied directly from values in a corresponding data field in the retrieved subset 612, and/or values generated by modifying, combining, or otherwise operating upon values in one or more data fields in the retrieved subset 612. The use of such data fields as model input data fields facilitates the machine learning model in weighing these factors directly.

After training set builder module 608 generates training data sets 614, training set builder module 608 passes the training data sets 614 to model trainer module 618. In example embodiments, model trainer module 618 is configured to apply the model input data fields of each training data set 614 as inputs to one or more machine learning models. Each of the one or more machine learning models is programmed to produce, for each training data set 614, at least one output intended to correspond to, or “predict,” a value of the at least one result data field of the training data set 614. “Machine learning” refers broadly to various algorithms that may be used to train the model to identify and recognize patterns in existing data in order to facilitate making predictions for subsequent new input data.

Model trainer module 618 is configured to compare, for each training data set 614, the at least one output of the model to the at least one result data field of the training data set 614, and apply a machine learning algorithm to adjust parameters of the model in order to reduce the difference or “error” between the at least one output and the corresponding at least one result data field. In this way, model trainer module 618 trains the machine learning model to accurately predict the value of the at least one result data field. In other words, model trainer module 618 cycles the one or more machine learning models through the training data sets 614, causing adjustments in the model parameters, until the error between the at least one output and the at least one result data field falls below a suitable threshold, and then uploads at least one trained machine learning model 616 to spend model module 606 for application to generating recommendations 620. In exemplary embodiments, model trainer module 618 may be configured to simultaneously train multiple candidate machine learning models and to select the best performing candidate for each result data field, as measured by the “error” between the at least one output and the corresponding result data field, to upload to spend model module 606.

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

As model trainer module 618 cycles through the training data sets 614, model trainer module 618 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 618 provides an advantage by automatically discovering and properly weighting complex, second-or third-order, and/or otherwise nonlinear interconnections between the model input data fields and the at least one output. Absent the machine learning model, such connections are unexpected and/or undiscoverable by human analysts.

AI/ML module 218 of the present disclosure is configured to operate on input data related to financial transactions, access additional data, identify spend and funding patterns, and identify fraudulent and non-fraudulent transactions. In one exemplary embodiment, AI/ML module 218 executes the spend model module 606 programmed to learn, without limitation, outcomes of transactions based upon varying events and details, relevant data sources for evidence, the queries used to prompt a user to provide relevant information, features of financial transactions related to potential fraud, and the like.

To facilitate this learning, AI/ML module 218 includes one or more of database 602 at which the data, including requests, responses, feature codes, evidence, outcomes, etc., is stored. This data becomes one or more input training sets used by training set builder 608. Model outputs can be formatted for presentation or review as visual representations of recommendations, as text-based or natural language recommendations, and the like. In exemplary embodiments, spend model module 606 may compare feedback, and may route a comparison result 622 generated by comparing recommendation 620 to the feedback to a model updater module 624 of AI/ML module 218. Model updater module 624 is configured to derive a correction signal 626 from comparison results 622 received for one or more recommendations and to provide correction signal 626 to model trainer module 618 to enable updating or “re-training” of the at least one machine learning model to improve performance. The retrained at least one machine learning model 616 may be periodically re-uploaded to spend model module 606. Spend model module 606 may be configured to provide an output 628 that may be used in a variety of ways, as described herein.

AI/ML module 218 may also be configured to use data 604 and/or an output from spend model module 606 to generate and/or be used in association with a fraud model module 630 for generating and providing a fraud detection and/or prediction model for controlling fraud-based operations of AI/ML module 218, and generating action recommendations in response to operational requests, and the like.

In exemplary embodiments, AI/ML module 218 includes a training set builder module 632 that is configured to interface with spend model module 606 to receive an output 628 from spend model module 606, and to submit one or more queries 634 to database 602 to retrieve subsets 636 of data 604, and to use those subsets 636 to build training data sets 638 for generating a fraud model via fraud model module 630. Output 628 may include, for example, the latest parameters of the latest spend model. For example, query 634 may be configured to retrieve certain fields from data 604 for historical data including past fraudulent transactions and characteristics of such, including fraud data originated by certain POS or merchants, transaction history for a customer, and the like.

In exemplary embodiments, training set builder module 632 may be configured to derive training data sets 638 from retrieved subsets 636. Each training data set 638 corresponds to a historical data 604 (“historical” in this context means completed in the past, as opposed to completed in real-time with respect to the time of retrieval by training set builder module 632, and may also correspond to information within output 628 from spend model module 606, where the output 628 from spend model module 606 provides training set builder module 632 with the latest spending parameters of the spend model so that the training set builder module 632 can more accurately train the fraud model to detect and/or predict fraudulent transactions). In other words, spend model module 606 and fraud model module 630 may have a working (e.g., symbiotic) relationship where spend model module 606 feeds training set builder module 632 of fraud model module 630 so that each model learns and grows over time to better determine, predict, and/or label fraud. For example, the ability of the fraud model to predict fraud may be based on analyzing a series of transactions that are atypical to known common transactions analyzed in connection with the spend model. In one example scenario, if multiple online transactions are made in quick succession at a retailer that the user has never shopped at before, the fraud model may flag any next transaction as fraudulent due to the detect transaction anomalies and the next transaction being temporally adjacent other likely fraudulent transactions. Additionally, or alternatively, fraud model module 630 may be configured to feed spend model module 606, where an on output (e.g., output 650) from fraud model module 630 may be fed into spend model module 606 (e.g., via training set builder 608) so that spend model module 606 operates according to the latest parameters of fraud model module 630. Each training data set 638 may include “model input” data fields along with at least one “result” data field representing a historical outcome associated with the model input. The model input data fields represent factors that may be expected to, or unexpectedly be found during model training to, have some correlation.

In exemplary embodiments, the model input data fields in training data sets 638 may be generated from data fields in subset 636 corresponding to historical data 604. In other words, a trained machine learning model 640 produced by a model trainer module 642 for use by fraud model module 630 is trained to make predictions based on input values that can be generated from the data fields in data 604. Values in the model input data fields may include values copied directly from values in a corresponding data field in the retrieved subset 636, and/or values generated by modifying, combining, or otherwise operating upon values in one or more data fields in the retrieved subset 636. The use of such data fields as model input data fields facilitates the machine learning model in weighing these factors directly.

After training set builder module 632 generates training data sets 638, training set builder module 632 passes the training data sets 638 to model trainer module 642. In example embodiments, model trainer module 642 is configured to apply the model input data fields of each training data set 638 as inputs to one or more machine learning models, such as fraud model module 630. Each of the one or more machine learning models is programmed to produce, for each training data set 638, at least one output intended to correspond to, or “predict,” a value of the at least one result data field of the training data set 638. “Machine learning” refers broadly to various algorithms that may be used to train the model to identify and recognize patterns in existing data in order to facilitate making predictions for subsequent new input data.

Model trainer module 642 is configured to compare, for each training data set 638, the at least one output of the model to the at least one result data field of the training data set 638, and apply a machine learning algorithm to adjust parameters of the model in order to reduce the difference or “error” between the at least one output and the corresponding at least one result data field. In this way, model trainer module 642 trains the machine learning model to accurately predict the value of the at least one result data field. In other words, model trainer module 642 cycles the one or more machine learning models through the training data sets 638, causing adjustments in the model parameters, until the error between the at least one output and the at least one result data field falls below a suitable threshold, and then uploads at least one trained machine learning model 640 to fraud model module 630 for application to generating recommendations. In exemplary embodiments, model trainer module 642 may be configured to simultaneously train multiple candidate machine learning models and to select the best performing candidate for each result data field, as measured by the “error” between the at least one output and the corresponding result data field, to upload to fraud model module 630.

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

As model trainer module 642 cycles through the training data sets 638, model trainer module 642 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 642 provides an advantage by automatically discovering and properly weighting complex, second-or third-order, and/or otherwise nonlinear interconnections between the model input data fields and the at least one output. Absent the machine learning model, such connections are unexpected and/or undiscoverable by human analysts.

AI/ML module 218 of the present disclosure is configured to operate on input data related to financial transactions, access additional data, and generate analysis identifying fraudulent and non-fraudulent transactions. In one exemplary embodiment, AI/ML module 218 executes the spend model module 606 and the fraud model module 630 programmed to learn, without limitation, outcomes of transactions based upon varying events and details, relevant data sources for evidence, the queries used to prompt a user to provide relevant information, features of financial transactions related to potential fraud, and the like.

To facilitate this learning, AI/ML module 218 includes one or more databases 602 at which the data, including requests, responses, feature codes, evidence, outcomes, etc., is stored. This data becomes one or more input training sets used by the training set builder 632. Model outputs can be formatted for presentation or review as visual representations of recommendations, as text-based or natural language recommendations, and the like. In exemplary embodiments, fraud model module 630 may compare feedback, and may route a comparison result 644 generated by comparing recommendation to the feedback to a model updater module 646 of AI/ML module 218. Model updater module 646 is configured to derive a correction signal 648 from comparison results 644 received for one or more recommendations and to provide correction signal 648 to model trainer module 642 to enable updating or “re-training” of the at least one machine learning model to improve performance. The retrained at least one machine learning model 640 may be periodically re-uploaded to fraud model module 630. Fraud model module 630 may interface via output 650. Beyond sharing the potential to share output 628 with fraud model module 630 and share output 650 with spend model module 606, other aspects of the two models may be shared with respect to the interfacing of the two models together, including but not limited to sharing of trained learning models 616, 640 and comparison results 622, 644 between the models (or any other aspects of the models shown in FIG. 6A, such as correction signals 626, 648). The spend model and the fraud model may be referred to individually as separate machine learning modules, or as being within a machine learning module (e.g., the machine learning module includes both the spend model and the fraud model).

FIG. 6B illustrates the determination of spending, funding, and fraud parameters according to one embodiment of the present disclosure. Transaction data from transactions 306 of account holder 102 (e.g., performed via transaction device 112) may be stored as transaction data 652 within UWLA computing system 106. Data 652 may be processed via transaction module 420 and fed into AI/ML module 218, which includes spend model module 606 and fraud model module 630 for determining spend and/or fraud patterns. Output 628 from spend model module and output 654 from spend module 422 may be used to generate spending parameters 656 and input parameters 658. Output 650 from fraud model module 630 and output 660 from fraud module 424 may be used to generate fraud parameters 662. Spending parameters 656 and input parameters 658 may then be stored in spend profile 326 of the user, and fraud parameters 662 may be stored in fraud profile 328 of the user. Each of (i) the model derived from spend model module 606 and fraud model module 630, (ii) spending parameters 656, input parameters 658, and fraud parameters 662, and (iii) spend profile 326 and fraud profile 328 may all continuously updated as new transactions as processed (alternatively updates may push within certain prescribed frequencies). This enables the user's UWLA to have real-time financial accuracy and reflect, for example, a user's changing spending habits and/or funding needs. Data 652 may be stored in and/or accessed from database 212 and/or storage system 220.

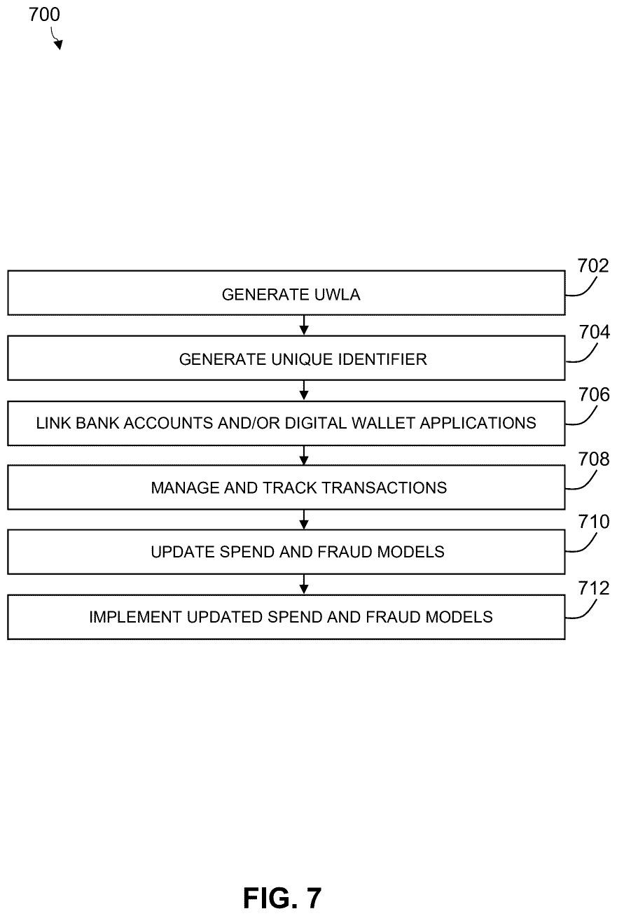

FIG. 7 illustrates an example method 700 for creation, implementation, and operation of a UWLA such as UWLA 312 shown in FIG. 3A. Method 700 includes generating 702 a UWLA such as UWLA 312. This may be performed by way of API module 314 and modules such as integration module 408, user registration module 410, auth. module 412, compliance module 416, and/or security module 418, with reference to applicable rules within rules 404, as described herein. This may also include populating applicable tables within tables 406, as described herein. For example, UWLA computing system 106 may be configured to intake user information into applicable tables of tables 406 and/or evaluate user information against applicable rules in rules 404 at the account creation process via the functionality provided by these modules. Method 700 also includes generating 704 a unique identifier such as RTP ID 322 shown in FIG. 3A. This may be performed by way of API module 314 and modules such as authorization module 412, ID generation module 414, compliance module 416, and/or security module 418, with reference to applicable rules of rules 404, as described herein. For example, ID generation module 414 may be configured to use an ID generating algorithm to generate a unique identifier such as RTP ID 322 in conjunction with authorization/authentication, compliance, and security functions of auth. module 412, compliance module 416, and/or security module 418, and applicable authorization/authentication, compliance, and security rules of rules 404, as described herein. This may include referencing any ID rules of rules 404 relating to the proper format of an RTP ID, so that ID generation module 414 generates compliant RTP IDs.

Method 700 further includes linking 706 bank accounts and/or digital wallet applications such as accounts 302/304 and digital wallets 308/310. This may be performed by way of API module 314 and modules such as integration module 408, auth. module 412, ID generation module 414, compliance module 416, and/or security module 418, and applicable rules of rules 404, as described herein.

Once a UWLA such as UWLA 312 is set up and operational, the spend and fraud functionality of UWLA computing system 106 may be activated. In this regard, method 700 further includes managing and tracking 708 transactions. This may be performed by way of API module 314 and modules such as AI/ML module 218 (including spend model module 606 and/or fraud model module 630), transaction module 420, spend module 422, and/or fraud module 424, and applicable rules of rules 404, as described herein. Storage system 220 may be configured to store transactions data of one or more account holders such as account holder 102, as well as historical data from any plurality of users for purposes of learning the spending behavior of any given account holder. This learned behavior is then utilized within UWLA computing system 106 to both appropriately fund UWLAs such as UWLA 312, use UWLAs for providing payment via the funds in the UWLAs, and/or detecting fraud in connection with usage of the UWLAs. This further enhances the streamlined functionality provided by UWLA computing system 106, because each UWLA such as UWLA 312 becomes personalized for each account holder. Managing and tracking 708 may also include managing the UWLA according to input parameters such as input parameters 658, as described herein. Method 700 further includes updating 710 the spend and fraud models, and implementing 712 the updated spend and fraud models continuously. This again may be performed by way of API module 314 and modules such as AI/ML module 218 (including spend model module 606 and/or fraud model module 630), transaction module 420, spend module 422, and/or fraud module 424, and applicable rules of rules 404, as described herein. For example, as the spend and fraud models acquire more and more data over time from usage of a UWLA such as UWLA 312, the models will become more accurate and effective in predicting user behavior. This means that the funding of UWLA 312 will become more and more nuanced and well-trained over time, for example to be able to accurately predict and/or adjust for seasonal spend such as during the holidays, periodic spend such as birthdays, and/or recurring spend such as monthly bills (e.g., utilities) and/or weekly expenditures (e.g., transit costs). In doing so, UWLA 312 may consistently stay funded with a sufficient amount of money to cover such expenditures so that a user does not need to use any other account to conduct transactions if they so desire.

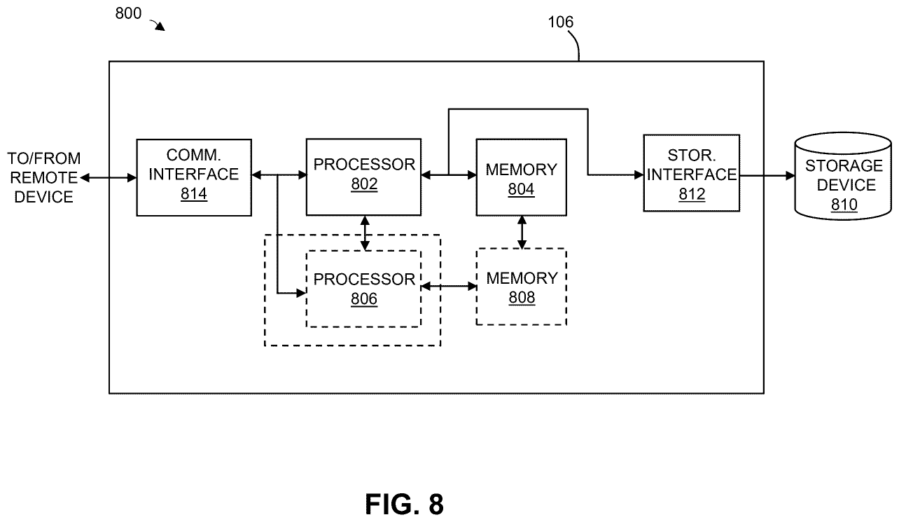

FIG. 8 illustrates an example configuration 800 of UWLA computing system 106 in accordance with one example embodiment of the present disclosure. Configuration 800 of UWLA computing system 106 may include a processor 802 operatively coupled with a memory 804. In some embodiments, UWLA computing system 106 may include one or more additional processors 806 operatively coupled with one or more additional memories 808, where the processors 802, 806 and memories 804, 808 may be operatively coupled with one another, and may be configured to provide parallel computing functions (e.g., to assist with resource heavy computing tasks). Additional processors 806 and additional memories 808 may be integrated with UWLA computing system 106, or may be integrated with one or more other (e.g., external) computing systems that is/are operatively coupled with UWLA computing system 106. Configuration 800 of UWLA computing system 106 may also include a storage device 810 configured to store data, and be accessible via storage interface 812. While storage device 810 is shown in FIG. 10 as being external to UWLA computing system 106, storage device 810 may be integrated with UWLA computing system 106. Storage device 810 may be embodied as storage system 220 shown in FIG. 2 (or vice versa, where storage system 220 may have a storage interface that is the same as or similar to storage interface 812)), or other storage devices within subsystem 200. UWLA computing system 106 may communicate (e.g., via network 206) with other devices (e.g., remote devices) within subsystem 200 as shown in FIG. 2 via a communication interface 814.

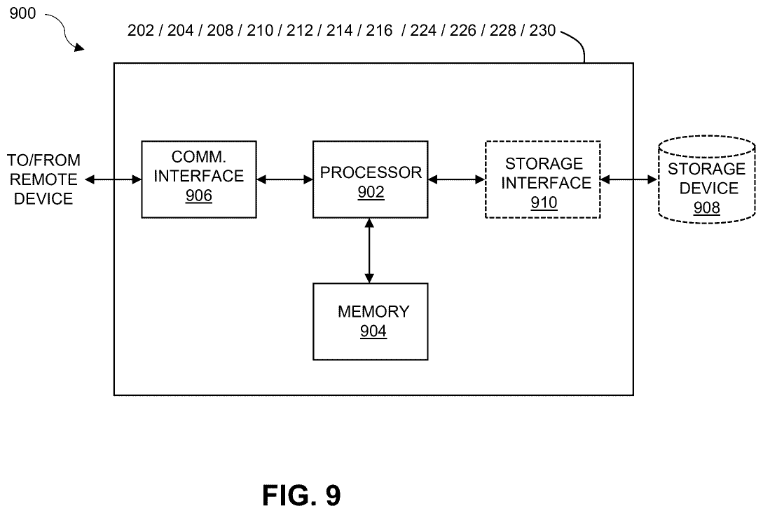

FIG. 9 illustrates an example configuration 900 of the various client computing devices (e.g., 202, 204, 224, 228), databases (e.g., 212), and/or server devices (e.g., 208, 210, 214, 216, 226, 230) in accordance with one example embodiment of the present disclosure. Configuration 900 includes a processor 902 operatively coupled with a memory 904. The various devices (e.g., 202, 204, etc., and/or 208, 210, etc.) may communicate with other devices (e.g., remote devices) within subsystem 200 shown in FIG. 2 via a communication interface 906 operatively coupled to processor 902. In some embodiments, processor 902 is operatively coupled to storage device 908 via a storage interface 910, to access or store data within storage device 908. Storage device 908 may be standalone storage or embodied as any storage device within subsystem 200 as described herein.

FIG. 10 illustrates an example configuration 1000 of user computing device 222 used in conjunction with UWLA computing system 106, such as within subsystem 200. Configuration 1000 includes a processor 1004 operatively coupled with a memory 1006. Configuration 1000 may also include at least one media output component 1008 for presenting information to user 1002. In some embodiments, media output component 1008 includes an output adapter such as a video adapter and/or an audio adapter. An output adapter is operatively coupled to processor 1004 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones). In some embodiments, user computing device 222 includes an input device 1010 for receiving input from user 1002. Input device 1010 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 1008 and input device 1010. Configuration 1000 may include a server (not shown) configured to provide access to resources, data, services, and/or programs to other computers. Configuration 1000 further includes a communication interface 1012 so that user computing device 222 may communicate with other computing devices (e.g., remote devices) within subsystem 200 shown in FIG. 2.

In some embodiments, user computing device 222 may be a smartphone of account holder 102, where user 1002 is account holder 102 and computing device 222 is used by account holder 102 to make payments using UWLA app 502 as shown in FIGS. 5A-5F. In other embodiments, user computing device 222 may be a computing device of an entity that provides, owns and/or operates UWLA computing system 106, where user 1002 may be an employee of the entity, for example. In such an embodiment, user 1002 may review outputs from UWLA computing system 106, such as outputs 628 and 650 from models 606 and 630 shown in FIG. 6A, respectively. These outputs may be output in a user-readable format for presentation to the user 1002, so that the user 1002 may analyze the results (e.g., for purposes of verifying the accuracy of the spend and/or fraud predictions and/or outputs 628 and 650 from models 606 and 630), for purposes of updating, evaluating, and/or refining the models. In yet further embodiments, transaction processing device 112 may be configured in a manner the same as or similar to configuration 1000, where user 1002 may be the same as or similar to account holder 102 (e.g., in an in-store scenario, user 1002 is an in-store customer using transaction processing device 112 to make an in-store purchase). In some embodiments, transaction processing device 112 may be configured as a user computing device 222 of a bank or other entity that creates UWLAs for their customers. For example, an employee of a bank such as issuer bank 110 may have a user computing device 222 for creation of UWLAs for customers. In connection with the RTP ID process shown in FIG. 3B, in some embodiments an account holder 102 can, on their own (such as via UWLA app 502) initiate the RTP ID issuance process via their personal user computing device 222 such as a smartphone. In other embodiments, a bank employee can use a bank user computing device 222 in the form of a bank workstation computer to initiate the RTP ID issuance process on behalf of the customer.

Each of the processors (e.g., 802, 806, 902, 1004) described in connection with FIGS. 8-10 may be configured to execute instructions that may be stored in the corresponding memories (e.g., 804, 808, 904, 1006) shown in and described in connection with FIGS. 8-10, for example. The processors may include one or more processing units (e.g., in a multi-core configuration) for executing instructions, and may be configured to operate in a parallel processing environment as described herein. The instructions may be executed within a variety of different operating systems on the respective systems, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.). The memories may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

Each of the storage devices (e.g., 810, 908) shown in and described in connection with FIGS. 8 and 9 may include one or more computer-readable media, such as one or more hard disk drives or solid state disks in a redundant array of inexpensive disks (RAID) configuration, and further may include a storage area network (SAN) and/or a network attached storage (NAS) system. Each of the storage interfaces (e.g., 812, 910) shown in and described in connection with FIGS. 8 and 9 may be any component capable of providing the processors with access to the storage devices. Storage interfaces may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processors with access to the storage devices.

Each of the various communication interfaces (e.g., 814, 906, 1012) shown in and described in connection with FIGS. 8-10 may be communicatively couplable to a remote device such as a server system (e.g., 208, 210, 214, 216, etc.) or a web server, and may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)). For example, communication interface 814 may receive data from payment network server 208 and/or issuer computing system 204 via the Internet, as illustrated in FIG. 2.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications or code) include machine instructions for a programmable processor and can be implemented in a high-level procedural and/or object-oriented programming language, and/or in assembly/machine language. As used herein, the terms “machine-readable storage medium” and “computer-readable storage medium” refer to any computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term “machine-readable signal” refers to any signal used to provide machine instructions and/or data to a programmable processor. The machine-readable storage medium and computer-readable medium do not include transitory signals.

The above-described embodiments of a method and system of computing velocities in an efficient manner within a distributed computing systems framework provides a cost-effective and time-saving means for analyzing a high volume of transaction data in payment network platforms. As a result, the methods and systems described herein facilitate leveraging a payment network's assets to improve analysis of data contained within the network, to thereby improve the quality of data within the network.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A unified wallet link account (UWLA) computer system for providing a secure and intelligent unified wallet link account, the computer system comprising:
at least one memory device for storing data; and
at least one processor in communication with the at least one memory device, the at least one processor programmed to:
generate a unified wallet link account (UWLA) for a user based on user information, the user being an account holder of the UWLA;
generate a unique identifier associated with the UWLA;
electronically link the UWLA to (i) one or more funding accounts of the user, and (ii) one or more external payment services using the unique identifier;
analyze, via one or more an artificial intelligence (AI) models associated with the UWLA, transaction data associated with the user and the one or more funding accounts;
determine, based on an output of the one or more AI models, one or more spending patterns of the user from the analyzed transaction data;
determine, based on the one or more spending patterns, input parameters for the UWLA; and
electronically fund the UWLA based on the determined input parameters.

2. A UWLA computer system in accordance with claim 1, wherein the at least one processor is further programmed to:
determine, via the one or more AI models, and based at least on the determined spending parameters, fraud parameters for the UWLA; and
analyze, via the one or more AI models and the determined fraud parameters, one or more transactions of the user for fraud.

3. A UWLA computer system in accordance with claim 2, wherein the at least one processor is further programmed to:
build, in association with the UWLA, (i) a spend profile for the user based on the determined spending parameters, and (ii) a fraud profile for the user based on the determined fraud parameters.

4. A UWLA computer system in accordance with claim 3, wherein the at least one processor is further programmed to:
refer to information contained in the output of the one or more AI models to build each of the spend profile and the fraud profile.

5. A UWLA computer system in accordance with claim 4, wherein the at least one processor is further programmed to:
refer to information contained within the spend profile to electronically fund the UWLA.

6. A UWLA computer system in accordance with claim 1, wherein the one or more external services includes at least one of a real-time payment service and a digital wallet service.

7. A UWLA computer system in accordance with claim 6, wherein the unique identifier is generated in conjunction with a provider of the real-time payment service.

8. A UWLA computer system in accordance with claim 1, wherein the one or more funding accounts of the user includes one or more bank accounts of the user, and the at least one processor is further programmed to:
initiate an electronic transfer of funds from the one or more bank accounts to electronically fund the UWLA based on the determined input parameters.

9. A UWLA computer system in accordance with claim 8, wherein the at least one processor is further programmed to:
refer to information contained within the output of the one or more AI models to determine the input parameters.

10. A UWLA computer system in accordance with claim 1, wherein the UWLA is isolated from the one or more funding accounts at least by the unique identifier.

11. A UWLA computer system in accordance with claim 1, wherein the input parameters include at least a timing parameter and a value parameter, and the electronic funding of the UWLA includes automatically electronically funding the UWLA with an amount based on at least one of the timing parameter and the value parameter.

12. A computer-implemented method for providing a unified wallet link account (UWLA) computer system for providing a secure and intelligent unified wallet link account using at least one processor in communication with at least one memory, the method comprising:
generating a unified wallet link account (UWLA) for a user based on user information, the user being an account holder of the UWLA;
generating a unique identifier associated with the UWLA;
electronically linking the UWLA to (i) one or more funding accounts of the user, and (ii) one or more external payment services using the unique identifier;
analyzing, via one or more an artificial intelligence (AI) models associated with the UWLA, transaction data associated with the user and the one or more funding accounts;
determining, based on an output of the one or more AI models, one or more spending patterns of the user from the analyzed transaction data;
determining, based on the one or more spending patterns, input parameters for the UWLA; and
electronically funding the UWLA based on the determined input parameters.

13. A computer-implemented method in accordance with claim 12, further comprising:
determining, via the one or more AI models, and based at least on the determined spending parameters, fraud parameters for the UWLA; and
analyzing, via the one or more AI models and the determined fraud parameters, one or more transactions of the user for fraud.

14. A computer-implemented method in accordance with claim 12, wherein the one or more external services includes at least one of a real-time payment service and a digital wallet service.

15. A computer-implemented method in accordance with claim 12, wherein the input parameters include at least a timing parameter and a value parameter, and the electronically funding the UWLA includes automatically electronically funding the UWLA with an amount based on at least one of the timing parameter and the value parameter.

16. One or more non-transitory computer-readable storage media with instructions stored thereon that, in response to being executed, cause a unified wallet link account (UWLA) computer system for providing a secure and intelligent unified wallet link account to:
generate a unified wallet link account (UWLA) for a user based on user information, the user being an account holder of the UWLA;
generate a unique identifier associated with the UWLA;
electronically link the UWLA to (i) one or more funding accounts of the user, and (ii) one or more external payment services using the unique identifier;
analyze, via one or more an artificial intelligence (AI) models associated with the UWLA, transaction data associated with the user and the one or more funding accounts;
determine, based on an output of the one or more AI models, one or more spending patterns of the user from the analyzed transaction data;
determine, based on the one or more spending patterns, input parameters for the UWLA; and
electronically fund the UWLA based on the determined input parameters.

17. One or more non-transitory computer-readable storage media in accordance with claim 16, wherein the instructions, in response to being executed, further cause the computer system to:
determine, via the one or more AI models, and based at least on the determined spending parameters, fraud parameters for the UWLA; and
analyze, via the one or more AI models and the determined fraud parameters, one or more transactions of the user for fraud.

18. One or more non-transitory computer-readable storage media in accordance with claim 16, wherein the one or more external services includes at least one of a real-time payment service and a digital wallet service.

19. One or more non-transitory computer-readable storage media in accordance with claim 16, wherein the UWLA is isolated from the one or more funding accounts at least by the unique identifier.

20. One or more non-transitory computer-readable storage media in accordance with claim 16, wherein the input parameters include at least a timing parameter and a value parameter, and the electronic funding of the UWLA includes automatically electronically funding the UWLA with an amount based on at least one of the timing parameter and the value parameter.
